(19) United States
(12) Patent Application Publication
(10) Pub. No.: US 2009/0263166 A1
(43) Pub. Date: Oct. 22, 2009

(54) IMAGE FORMING APPARATUS

(75) Inventors: Minoru Yoshida, Machida-shi (JP); Takeshi Watanabe, Yokohama-shi (JP); Masashi Takahashi, Yokohama-shi (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/424,978

(22) Filed: Apr. 16, 2009

Related U.S. Application Data
(60) Provisional application No. 61/046,160, filed on Apr. 18, 2008.
(60) Provisional application No. 61/046,164, filed on Apr. 18, 2008.

(51) Int. Cl. G03G 15/01

(52) U.S. Cl. 399/299; 399/302

(57) ABSTRACT

An image forming apparatus includes a plurality of image carrier members each configured to carry a latent image, a plurality of electrostatic chargers each configured to charge the image carrier member uniformly, a plurality of developing devices each configured to develop the latent image formed to the image carrier member by toner, a plurality of cleaners each configured to remove the toner remaining on the carrier member, an intermediate transfer member having a non-electroconductive material on which a developed image is transferred by one of the image carrier members and then another developed image is transferred over the developed image by another image carrier member and a plurality of transfer rollers each provided so as to oppose the image carrier member with the intermediary of the intermediate transfer member.

### CROSS-REFERENCE TO RELATED APPLICATION

This application claims the benefit of U.S. Provisional Applications No. 61/046,160, filed Apr. 18, 2008 and No. 61/046,164, filed Apr. 18, 2008.

### TECHNICAL FIELD

The present invention relates to an image quality preservation technology in an image forming apparatus.

### BACKGROUND

In recent years, a requirement for enhanced image quality grows in association with the proliferation of color image forming apparatuses. In an electrophotographic-type color image forming apparatus, a full color image is generally expressed by superimposing toner images in Y (yellow), M (magenta), C (cyan), and Bk(black).

In such the color image forming apparatus, an intermediate transfer belt is employed as a transfer device. The intermediate transfer belts in many color image forming apparatuses are formed of a single layer resin.

In JP-A-2003-206046, a configuration of an image forming apparatus having a resin belt as an intermediate transfer member is disclosed. A surface resistivity of the intermediate transfer belt is adjusted considering various factors such as an elastic modulus, thickness, and the like. If the surface resistivity of the intermediate transfer belt is set to a too high value, the belt is electrically charged, and hence a belt static eliminator is necessary. Therefore, increase in machine cost or upsizing of the apparatus may be resulted.

In the case of the color image forming apparatus which performs a multiple transfer, a transfer bias condition which enables both a color-superimposing transfer and a single-color transfer does not exist unless the surface resistivity of the intermediate transfer belt is adequately set, so that satisfactory images cannot be obtained.

If an electroconductive single-layer intermediate transfer belt is employed here in a color tandem image forming apparatus, 90% or more of single-color transfer efficiency, three-color-registration transfer efficiency and survival rate from reverse transfers can not be achieved. Therefore, there remain challenges to image quality, image concentration, toner consumption efficiency, user-friendliness of the apparatus, and so on.

In addition, if the electroconductive single-layer intermediate transfer belt is employed in the color tandem image forming apparatus, 90% or more of single-color transfer efficiency, three-color-registration transfer efficiency and survival rate from reverse transfers cannot be achieved, so that prevention of half-tone concentration difference due to a transfer memory cannot be achieved. Therefore, the color-tandem image forming apparatus still have challenges to image quality, image concentration, toner consumption efficiency, user-friendliness of the apparatus, and so on.

In the related art, a single layer resin belt including carbon dispersed therein is commercialized. However, it is balanced by trading off a toner usage efficiency to some extent (a more than sufficient amount of toner is placed on a photoconductive member to compensate residues or reverse transfer) or by trading off the image quality to some extent.

On the other hand, as disclosed in JP-A-2004-109982, a color image forming apparatus in which a cleanerless process having no cleaner for photoconductive members is proposed. The color image forming apparatus in which the cleanerless process is applied reuses untransferred toner without discarding the same, it has an advantage of avoidance the waste of toner. However, the color image forming apparatus in which the cleanerless process is applied, mechanisms for preventing various problems such as insufficient transfer performance, sequences on the side of the apparatus, and so on are provided. Therefore, the color image forming apparatus in which the cleanerless process is applied has problems of lowering of the substantial printing performance or increased cost due to the complication of the apparatus.

If the electroconductive single-layer intermediate transfer belt is used in the color image forming apparatus in which the cleanerless process is applied, it is difficult to solve a color-mixing problem and a problem of filming on the photoconductive member without trading off the printing performance as described in JP-A-05-88401.

Accordingly, it is an object of the invention to provide an image forming apparatus in which transfer performances and survival rate from reverse transfers are improved, so that the amount of consumption of toner is reduced, and high-quality color images are obtained.

### SUMMARY

According to one aspect of the present invention, there is provided an image forming apparatus including: a plurality of image carrier members each configured to carry a latent image; a plurality of electrostatic chargers each configured to charge the image carrier member uniformly; a plurality of developing devices each configured to develop the latent image formed to the image carrier member by toner; a plurality of cleaners each configured to remove the toner remaining on the carrier member; an intermediate transfer member having a non-electroconductive material on which a developed image is transferred by one of the image carrier members and then another developed image is transferred over the developed image by another image carrier member; a plurality of transfer rollers each provided so as to oppose the image carrier member with the intermediary of the intermediate transfer member; a first roller provided on the upstream side in the direction of travel of the intermediate transfer member; and a second roller provided on the downstream side in the direction of travel of the intermediate transfer member, wherein the intermediate transfer member satisfies conditions of σ₅₀>2.0×10¹⁰ (Ω/□), ρ₅₀₀. d>1.0×10³ (Ω·m²), and ρ₅₀/(Dst/V)<4.0×10¹¹ (Ω·m/sec) where Dst is a distance (m) between the adjacent image carrier members, V is a traveling velocity (m/sec) of the intermediate transfer member, d is a thickness (m) of the intermediate transfer member, σ₅₀ is a surface resistivity measured with an applied voltage of 50V, ρ₅₀₀ is a volume resistivity measured with an applied voltage of 500V, and ρ₅₀ is a volume resistivity measured with an applied voltage of 50V.

### DESCRIPTION OF THE DRAWINGS

FIG. 1 is a perspective view showing an appearance of a color image forming apparatus.

FIG. 2 is a schematic drawing of an internal structure of the color image forming apparatus viewed from the front.

FIG. 3 is a graph showing the relation between the surface resistivity of an intermediate transfer belt and the result of visual evaluation of the image blur level.

FIGS. 4A, 4B and 4C are graphs of results of evaluations of the single-color transfer efficiency, the three-color-registration transfer efficiency, and the single-color survival rate from reverse transfer.

FIG. 5 is a table showing belt resistance characteristics on the basis of applied voltages.

FIGS. 6A, 6B and 6C are drawings showing operations of respective members in a station C for measuring the transfer efficiency of a single color of Cyan.

FIG. 7 is a graph showing the volume resistivity of the intermediate transfer belt and the maximum value of the three-color-registration transfer efficiency.

FIG. 8 is a graph showing the relation between the potential of a photoconductive drum after the passage through a primary transfer section and the potential difference of a transfer memory.

FIG. 9 is a graph showing the relation of the product of the volume resistivity and the thickness of the belt with respect to the transfer memory potential difference.

FIG. 10 is a schematic drawing showing an interior structure of the color image forming apparatus in which a cleanerless process is applied viewed from the front.

FIGS. 11A and 11B are appearance drawings showing examples of a blending member.

FIG. 12 is a graph showing the relation between the single-color survival rate from reverse transfer and the color difference of images in a single color of Cyan between an initial image and an image printed after printing on 100 k sheets.

FIG. 13 is a table showing results of the printing life test with 6% of Cyan.

FIG. 14 is a graph in which the lateral axis represents the volume resistivity of the intermediate transfer belt and the vertical axis represents the maximum value of the three-color transfer efficiency.

FIG. 15 is a table showing belt resistance characteristics on the basis of applied voltages.

FIGS. 16A, 16B, 16C and 16D are graphs of results of evaluations of the single-color transfer efficiency, the three-color registration transfer efficiency, and the single-color survival rate from reverse transfer.

FIG. 17 is a graph showing the relation of the product of the volume resistivity and the thickness of the belt with respect to the single-color survival rate from reverse transfer.

FIG. 18 is a graph showing the relation between ρ₅₀/(Dst/V), and the three-color-registration transfer efficiency.

FIG. 19 is a table showing results of printing tests conducted using the belts A to G, respectively.

FIG. 20 is a graph showing a relation of a product of the volume resistivity and the thickness of the belt with respect to the single-color survival rate from reverse transfer.

FIG. 21 is a table showing results of printing test conducted using the belts A to G, respectively.

FIGS. 22A and 22B are side cross-sectional views of the intermediate transfer belt having a multiple-layer structure.

FIG. 23 is a table showing characteristics of belts a to j.

FIGS. 24A, 24B, 24C, 24D, 24E, 24F, 24G, 24H, 24I and 24J are graphs of results of evaluations of the single-color transfer efficiency, the three-color registration transfer efficiency, and the single-color survival rate from reverse transfer.

FIG. 25 is a table showing the results of evaluations of surface resistivities of the back surfaces of the belts a to j and the image blurs thereof.

FIG. 26 is a drawing showing the result of evaluation of the surface resistivity of a front surface layer of the intermediate transfer belt and the image blur thereof.

FIG. 27 is a graph showing the relation of the product of the volume resistivity and the thickness of the belt with respect to the single-color survival rate from reverse transfer.

FIG. 28 is a graph showing the relation between ρ₅₀/(Dst/V), and the three-color-registration transfer efficiency.

FIG. 29 is a table showing characteristics of belts a to j.

FIG. 30 is a graph showing the relation of the product of the volume resistivity of the belt and the thickness of the belt with respect to the transfer memory potential difference.

FIG. 31 is a graph showing the relation of the product of the volume resistivity and the thickness of the belt with respect to the single-color survival rate from reverse transfer.

FIG. 32 is a table showing characteristics of belts a to j.

FIG. 33 is a table showing occurrence of an insufficient image due to a hole on a photoconductor according to the rubber strength of an elastic layer.

### DETAILED DESCRIPTION

Referring now to the drawings, an embodiment will be described below.

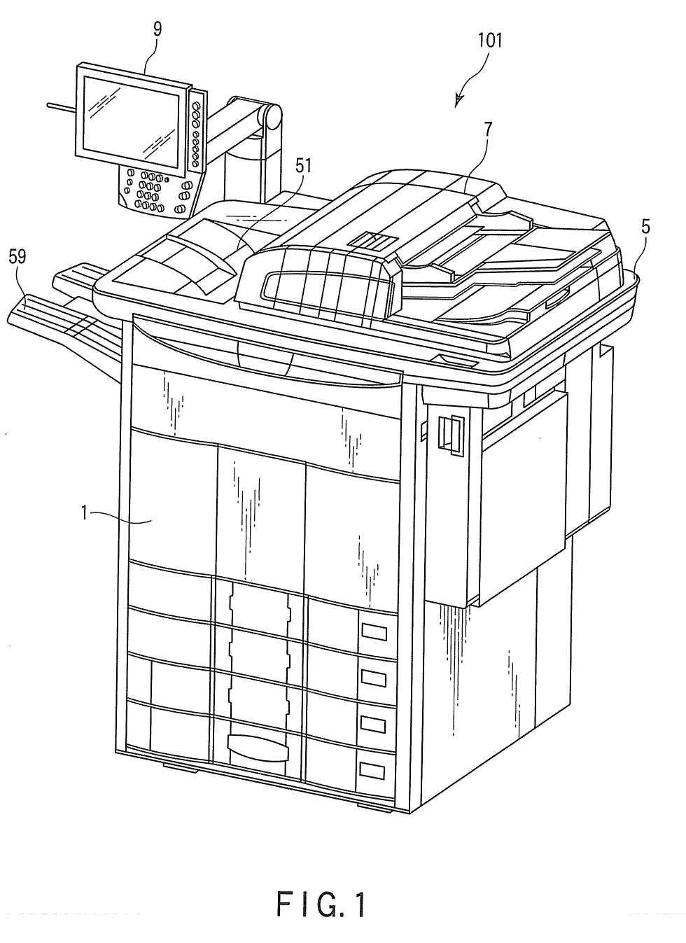

FIG. 1 is a perspective view showing an appearance of a color image forming apparatus 101 according to the embodiment. The color image forming apparatus 101 is, for example, a color copying machine of a four-drum tandem system. The color image forming apparatus 101 includes an image forming unit 1 configured to output image data as an output image referred to as, for example, a hard copy, or a printout, a sheet supply unit 3 configured to be able to supply the image forming unit 1 with a sheet (output medium) of a given size used for output the image, and a scanner (image scanning unit) 5 configured to read the image data as an object to be formed into an image in the image forming unit 1 from an object having the image data held thereon (hereinafter, referred to as an original document) as image data. Provided above the image forming unit 1 is an automatic document feeder 7 configured to discharge a scanned original document, if it is a sheet-type document, after the process of scanning of the image data in the image scanning unit 5 from a scanning position to a discharging position, and guide a next original document to the scanning position. The color image forming apparatus 101 also includes an instruction input unit for giving instructions for starting image formation in the image forming unit 1 or scanning of image data on the original document in the image scanning unit 5, that is, a display unit 9 as a control panel.

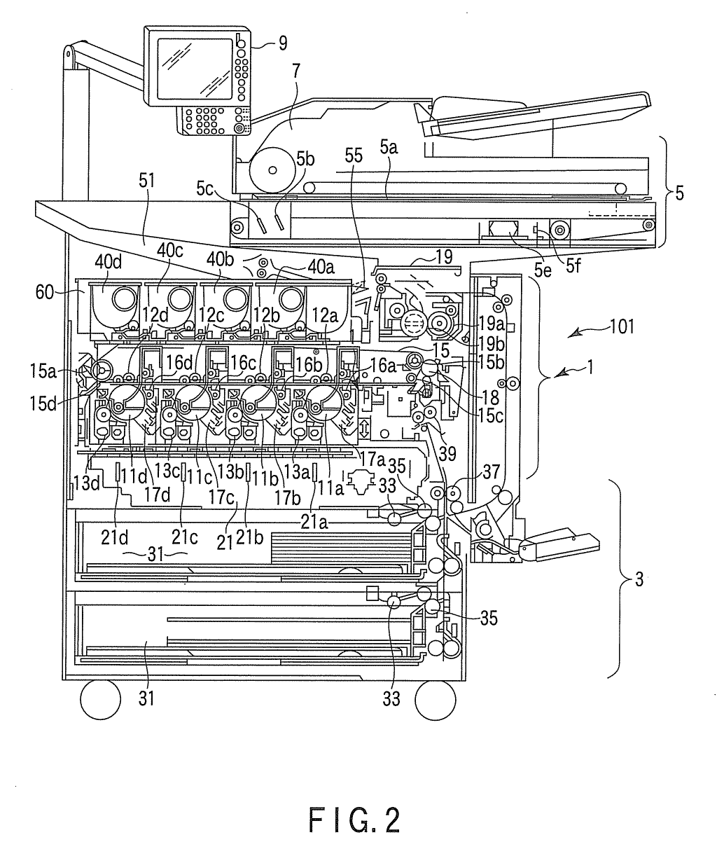

FIG. 2 is a schematic drawing showing an interior structure of the color image forming apparatus 101 in which a belt-shaped intermediate transfer member is employed viewed from the front. First of all, the structure of the image scanning unit 5 will be described. The image scanning unit 5 includes a transparent platen glass 5a configured to place an original document thereon, a light source 5b configured to light the original document, and a reflection mirror 5c configured to reflect light reflected from the original document. The light source 5b and the reflection mirror 5c are provided integrally with a document lighting unit 5d which is movable in the horizontal direction. The reflected light from the document lighting unit 5d passes through an imaging lens 5e placed in an optical path and received by the imaging lens 5e by a CCD (Charge Coupled Device) 5f.

Subsequently, a configuration of the image forming unit 1 will be described. Arranged above the image forming unit 1 are toner cartridges 40a, 40b, 40c, and 40d disposed in parallel. The toner cartridges 40a, 40b, 40c, and 40d are demountable and mountable with respect to a toner cartridge holding mechanism 60 provided on the front side of the image forming unit 1. The toner cartridges 40a, 40b, 40c, and 40d serve to supply toner in yellow, magenta, cyan, and black.

The image forming unit 1 includes first to fourth photoconductive drums 11a to 11d as image carrier members for holding latent images, developing devices 13a to 13d configured to develop latent images formed on the photoconductive drums 11a to 11d, an intermediate transfer belt 15 as a transferred member configured to hold developer images developed on the photoconductive drums 11a to 11d in a laminated state, cleaners 16a to 16d configured to remove residual toner on the photoconductive drums 11a to 11d from the individual photoconductive drums 11a to 11d, and electrostatic chargers 17a to 17d configured to cause the photoconductive drums 11a to 11d to be electrically charged evenly. The photoconductive drum 11a, a primary transfer roller 12a, the developing device 13a, the cleaner 16a, the electrostatic charger 17a, and an LD 21a are provided so as to oppose the intermediate transfer belt 15 as a set of image forming unit. In the image forming unit 1, the same components are provided also for the photoconductive drum 11b, the photoconductive drum 11c, and the photoconductive drum 11d. Therefore, the image forming unit 1 includes four stations as described above.

The image forming unit 1 also includes a transfer device 18 configured to transfer the developer image laminated on the intermediate transfer belt 15 to a sheet-type output medium such as a generally used normal paper which is not applied with a specific treatment, or an OHP sheet as a transparent resin sheet, and a fixing device 19 configured to fix the developer image transferred to a transferred medium to the output medium. The image forming unit 1 also includes an exposing device 21 having LDs 21a to 21d configured to irradiate the photoconductive drums 11a to 11d with a laser beam modulated according to the writing image data and form the latent images. The exposing device 21 may be configured with LEDs or the like.

The intermediate transfer belt 15 is stretched taut around a drive roller 15a configured to rotate the intermediate transfer belt 15, a tension roller 15b configured to regulate the tensile force applied to the intermediate transfer belt 15 to be constant, and a backup roller 15c for a secondary transfer.

Disposed respectively on the back surface side of the intermediate transfer belt 15 where the intermediate transfer belt 15 comes into contact with the photoconductive drums 11a to 11d (primary transfer section) are primary transfer rollers 12a to 12d so as to come into press contact with the photoconductive drums 11a to 11d via the intermediate transfer belt 15.

The transfer device 18 is disposed so as to come into contact with the intermediate transfer belt 15 on the side (outside) of the intermediate transfer belt 15 carrying the toner (secondary transfer section), and is disposed on the back surface side (inside) the intermediate transfer belt 15 so as to oppose the backup roller 15c. The backup roller 15c has an electrode opposite from the transfer device 18.

Disposed at a position of the intermediate transfer belt 15 where the drive roller 15a is provided on the opposite side of the drive roller 15a with the intermediary of the intermediate transfer belt 15 is a belt cleaner 15d disposed so as to come into contact with the intermediate transfer belt 15.

The first to fourth photoconductive drums 11a to 11d respectively hold electrostatic images (electrostatic latent images) in colors to be visualized (exposed) by the developing devices 13a to 13d having toner of one of colors from Y(yellow), M(Magenta), C(cyan), and Bk (black), and the order of arrangement is specified to a predetermined order according to the image forming process or the characteristics of the toner (developer). The intermediate transfer belt 15 holds the developer images in the respective colors formed by the first to fourth photoconductive drums 11a to 11d and the developing devices 13a to 13d corresponding thereto in sequence (of the formation of the developer image).

The photoconductive drum 11a provided in the first state (Y station) includes a photoconductive layer of organic or amorphous silicon system provided on a conductive base member. In this embodiment, an organic photoconductive member charged with a negative polarity will be described as an example. The photoconductive drum 11a is uniformly charged by the electrostatic charger 17a which is a known scorotron charger to, for example −500V. Subsequently, the photoconductive drum 11a is subjected to an image exposure by the LD 21a, so that an electrostatic latent image is formed on the surface thereof. At this time, the surface potential of the exposed photoconductive drum 11a becomes, for example, approximately −80V. Then, the electrostatic latent image on the photoconductive drum 11a is visualized by the developing device 13a.

The developing device 13a employs a two-component development system having negatively charged non-magnetic toner and magnetic carrier mixed together. The developing device 13a forms spikes of carrier on the developer roller having provided with a magnet, and applies a voltage of approximately −200V to −400V on the developer roller. On the surface of the photoconductive drum 11a, the toner is adhered to an exposed portion (image portion) exposed by the LD 21a, and no toner is adhered to a non-exposed portion (non-image portion).

The photoconductive drum 11a transfers a visualized image formed on the surface of the photoconductive drum 11a to a transferred member such as the intermediate transfer belt 15 which comes into contact thereto. The primary transfer roller 12a, which is a transfer member being in contact with the back surface of the intermediate transfer belt 15, supplies a transfer electric field to the photoconductive drum 11a. A positive voltage of approximately 300 to 2 kV is applied to the primary transfer roller 12a. After the visualized image is transferred to the intermediate transfer belt 15, the cleaner 16a removes residual toner remaining on the surface of the photoconductive drum 11a after the passage of the photoconductive drum 11a through the primary transfer section at a position before the electrostatic charger 17a charges the photoconductive drum 11a. The cleaner 16a collets the residual toner or the like in a waste toner box, not shown. On the surface of the photoconductive drum 11a, the above-described charging is repeated again after the removal of the residual toner or the like on the surface by the cleaner 16a.

Subsequently, as the image forming unit 1 from the second stage onward, the second stage (M station) will be descried as an example. The photoconductive drum 11b, the primary transfer roller 12b, the developing device 13b, the cleaner 16b, the electrostatic charger 17b, and the LD 21b are the same as the configuration of the first stage (Y station) described above. In the primary transfer section of the second stage (M station), the image formed in the first stage (Y station) and transferred to the intermediate transfer belt 15 approaches. Therefore, in the primary transfer section of the second stage (M station), transfer bias conditions might be somewhat different. For example, the bias is adjusted also by the amounts of charge of the toner in the respective colors. Depending on the transfer bias conditions, in the primary transfer section of the second stage (M station), a “reverse transfer” phenomenon in which part of the image formed in the first stage is transferred back to the photoconductive drum 11b on the second stage might occur. Also, the problems such that the image concentration is not sufficient or the waste toner box is filled to the top soon might occur, so that the transfer bias conditions are selected with the reverse transfer taken into consideration in the primary transfer section of the second stage (M station).

Configuration of the third stage (C station) and the fourth stage (Bk station) of the image forming unit 1 thereafter are the same as the second stage. In the intermediate transfer belt 15, a color image is formed by registered images formed and transferred in the four image forming stations.

The primary transfer rollers 12a to 12d are urethane sponges adjusted in resistance. The primary transfer rollers 12a to 12d are rollers formed of sponge of 106 Ω·cm in value of resistance and having a diameter of 14 mm with a shaft having a diameter of 8 mm extending through the center thereof. In this embodiment, the primary transfer rollers 12a to 12d are used as the primary transfer member. However, other member having an adequate resistance such as a transfer brush or a transfer blade may be applied as the primary transfer member. The electrostatic chargers 17a to 17d may be of a corona charging system, or of a contact charging system such as roller charging.

The intermediate transfer belt 15 is adjusted in surface resistivity by dispersing carbon in a polyimide resin having a thickness of 100 μm. The process velocity of the image forming unit 1 is 240 mm/sec, and the station to station distance (the distance between the photoconductors) is 80 mm.

The sheet supply unit 3 supplies an output medium to the transfer device 18 at a predetermined timing when the transfer device 18 transfers a developer image.

Cassettes which are mounted in a plurality of cassette slots 31 accommodate output media of given sizes. A pickup roller 33 takes out an output medium according to the image forming operation. The sizes of the output media correspond to the sizes of the developer image that the image forming unit 1 forms. A separation mechanism 35 prevents the pickup roller 33 from taking out two or more output medium from the cassette. A plurality of transporting rollers 37 carry an output medium which is limited to be one piece by the separation mechanism 35 toward an aligning roller 39. The aligning roller 39 delivers the output medium to a transfer position where the transfer device 18 comes into contact with the intermediate transfer belt 15 at a timing when the transfer device 18 transfers the developer image from the intermediate transfer belt 15. The cassette slots 31, the pickup roller 33, and the separation mechanism 35 are prepared by a plurality of numbers as needed, and the cassettes may be mounted on given different slots.

In this manner, the backup roller 15c and the transfer device 18 transfer an image formed of toner in plurality of colors transferred to the intermediate transfer belt 15, for example, to an output medium such as a paper in the second transfer section. The backup roller 15c is, for example, a grounded aluminum roller. The transfer device 18 applies a bias of a positive (+) polarity to transfer the toner to the output medium. As the transfer bias condition in the transfer device 18, a value adjusted according to the resistance of the transfer device 18, the environment, or the resistance of the output medium is selected. The transfer bias condition in the transfer device 18 is selected from values from +300 to 5V.

In this embodiment, the backup roller 15c is grounded and the positive bias is applied to the transfer device 18. However, a configuration of grounding the transfer device 18 and applying a negative bias to the backup roller 15c is also applicable.

The output medium on which the image data is fixed via the fixing device 19 is discharged to a paper discharge tray 51 defined on the side of the image scanning unit 5 and above the image forming unit 1. Here, the fixing device 19 includes a fixing roller 19a and a press roller 19d on the downstream side in terms of the direction of paper discharge. The developer image transferred to the output medium is melted by the fixing roller 19a heated to a temperature of 180° C. and the press roller, so that the image data is fixed to the output medium.

A color image forming apparatus 101 has a side paper discharge tray 59 on the side surface of the image forming unit 1. The output medium discharged from the fixing device 19 is guided to the side paper discharge tray 59 via a relay transfer unit 71 connected to a switching section 55.

Here, in the color image forming apparatus 101 in which the intermediate transfer belt 15 descried above is employed, a configuration in which the following problems are addressed is necessary.

### (1) Image Blur

If the surface resistivity of the intermediate transfer belt 15 is too low, the electrical field is formed in a pre-nip portion in the primary transfer section and a jumping transfer occurs, so that there arises a problem of image blur.

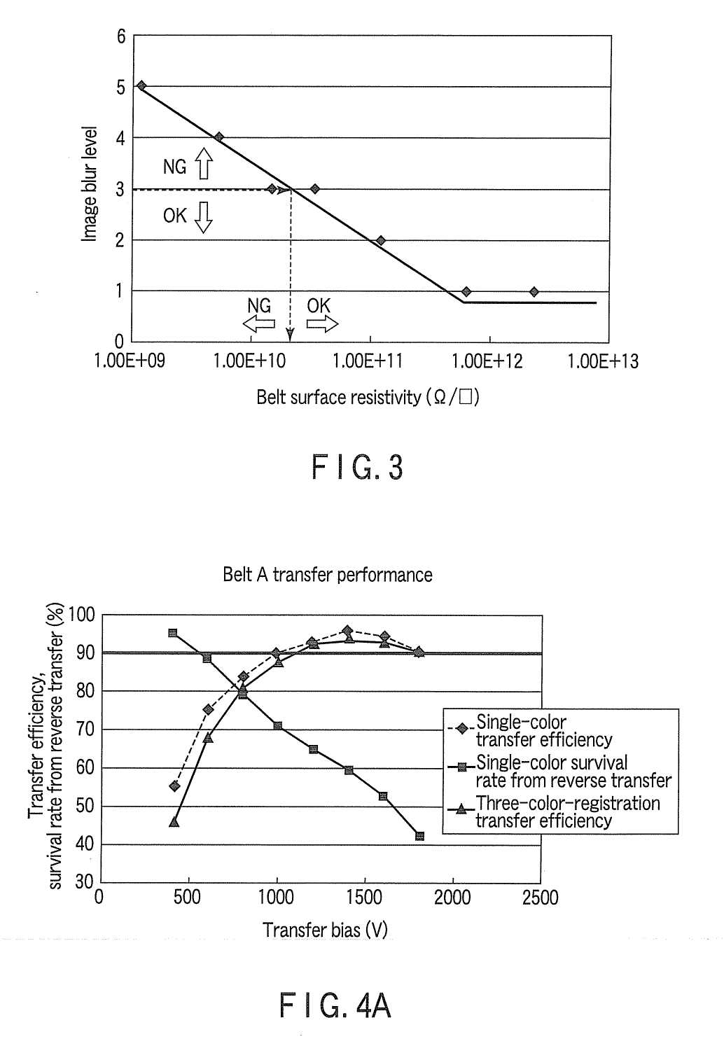

FIG. 3 is a graph showing the relation between the intermediate transfer belt 15 having different surface resistivities and the result of visual evaluation of the image blur level in character images. The quality of the image is improved with lowering of the evaluated value of the image blur level. The image blur level providing no problem in practical use is expressed by an evaluation value of 3. Therefore, it is understood that if the surface resistivity of the intermediate transfer belt 15 is 2×10¹⁰ Ω/□ or higher, there is no problem of the image blur.

The voltage of the intermediate transfer belt 15 nipped between the photoconductive drum 11a and the primary transfer roller 12a is not high. Therefore, the surface resistivity of the intermediate transfer belt 15 must be measured by applying a relatively low voltage. The surface resistivity of the intermediate transfer belt 15 here is measured by applying 50V using R8340A (manufactured by ADVANTEST Corporation). The closed adjustment value of the unit is assumed to be 3.

### (2) Transfer Efficiency

In the first stage (Y station), the second stage (M station), the third stage (C station), and the fourth stage (Bk station) respectively, it is required to transfer the toner to the intermediate transfer belt 15 by an amount as close to 100% as possible, and hold the image transferred in the previous stage on the intermediate transfer belt 15 as is.

Here, if the surface resistivity in the intermediate transfer belt 15 is low, the electric charge of the toner on the intermediate transfer belt 15 is inverted. The photoconductive drums 11b, 11c, and 11d in the stations from the next stage onward peel off the toner on the intermediate transfer belt 15. This phenomenon is referred to as the reverse transfer phenomenon. Therefore, the transfer image on the intermediate transfer belt 15 has a problem of being incapable of obtaining a sufficient image concentration. In addition, in the color registered portion of the transferred image, the color reproducible range is reduced due to the reverse transfer phenomenon on the intermediate transfer belt 15, so that the satisfactory image quality cannot be achieved. When the residual transfer toner or the reverse transfer toner on the intermediate transfer belt 15 is increased, the amount of residual toner is increased correspondingly. Therefore, the user is required to replace the waste toner box containing the waste toner collected by the cleaners 16a to 16d frequently. Consequently, there arises a problem of lowering of the operability of the color image forming apparatus 101.

In order to prevent the occurrence of the above-described problem, it is essential only that both the single-color transfer efficiency, the three-color-registration transfer efficiency and the single-color survival rate from reverse transfer do not fall below approximately 90%. In particular, when the transfer efficiency of three-color-registration of C, M, and Y is lower than 90%, the problem arises in color reproducible range. In the color image forming apparatus 101, satisfactory performance must be achieved in all the single-color transfer efficiency, the three-color-registration transfer efficiency, and the single-color survival rate from reverse transfer.

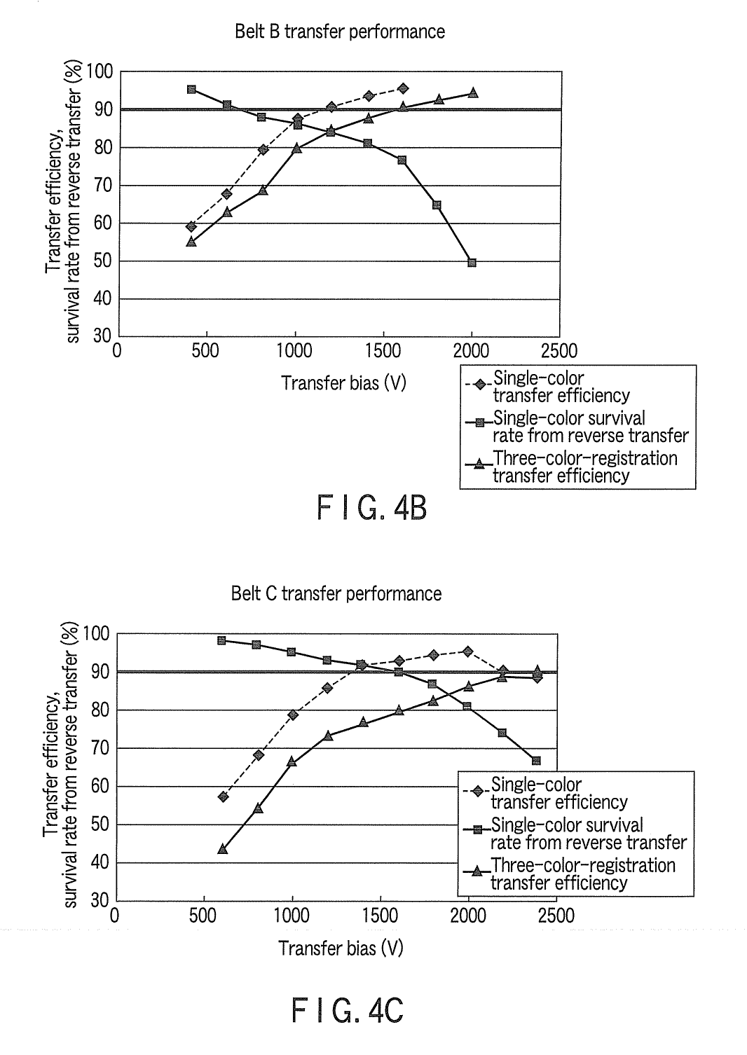

Here, FIGS. 4A, 4B, and 4C are graphs showing the single-color transfer efficiency, the single-color survival rate from reverse transfer, and the three-color-registration transfer efficiency in the C station in the third stage with respect to the transfer bias conditions when three different types of intermediate transfer belts 15 (belt A, belt B, and belt C) having different surface resistivities are used. The belt A, the belt B, and the belt C have different surface resistivities respectively by changing the amount of carbon dispersed in polyimide resin.

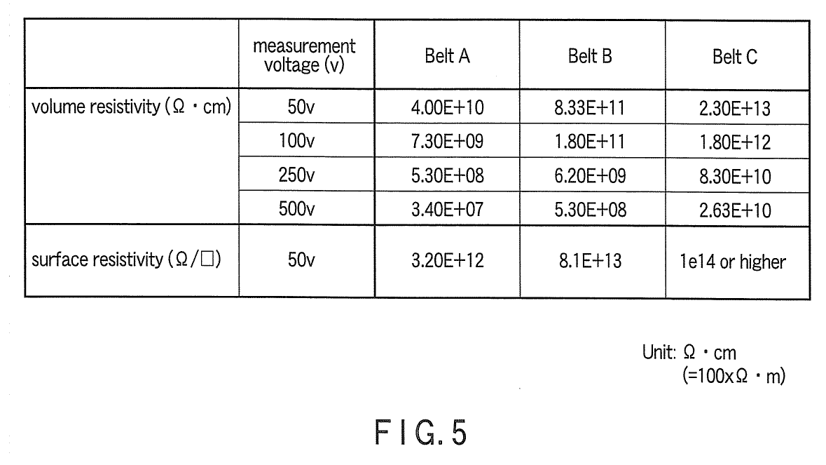

FIG. 5 is a table showing the resistance characteristics of the three types of belt; the belt A, the belt B, and the belt C for the respective the measurement voltages. The belt A, the belt B, and the belt C are formed of an electroconductive material provided with conductivity by dispersing carbon therein. The belt A, the belt B, and the belt C are different in volume resistivity depending on the applied voltage. The volume resistivities of the belt A, the belt B, and the belt C are measured by using R8340A (manufactured by ADVANTEST Corporation). The closed adjustment value of the unit is assumed to be 3. As shown in FIG. 5, the surface resistivities of the belt A, the belt B, and the belt C (measured by applying a voltage 50V) are all 2×10¹⁰ Ω/□ or higher, and hence the blur of the characters does not occur.

Subsequently, a method of measuring the single-color transfer efficiency, the single-color survival rate from reverse transfer, and the three-color-registration transfer efficiency in the C station will be described.

### <Transfer Efficiency of Single Color, Cyan: TRc>

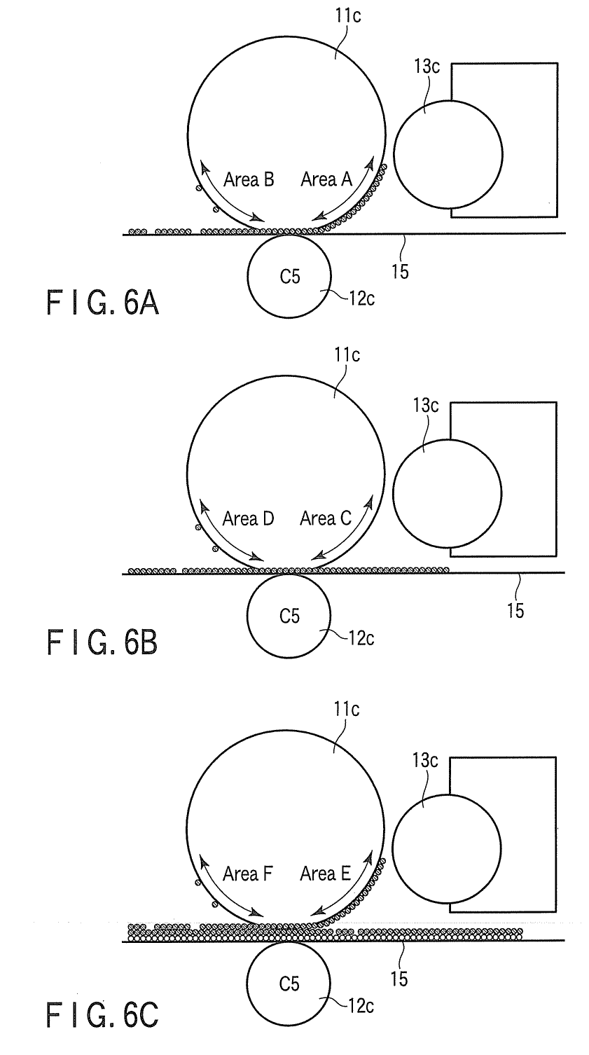

First of all, a method of measuring the transfer efficiency of the single color Cyan will be described. The color image forming apparatus 101 prints a solid image of Cyan onto the intermediate transfer belt 15 in the third station. FIG. 6A is a drawing showing actions of the respective members in the C station. In the C station, a control unit (not shown) adjusts the developing bias to be applied between the developing device 13c and the photoconductive drum 11c so that the amount of adhered toner of the solid image formed on the photoconductive drum 11c becomes 0.4-0.45 (mg/cm²). Then, the control unit suddenly stops the respective components in the C station while the solid image formed on the photoconductive drum 11c in the C station is being transferred to the intermediate transfer belt 15.

Here, the control unit measures an amount of adhered toner M1 (mg/cm²) formed on the photoconductive drum 11c before transferring the solid image in Cyan onto the intermediate transfer belt 15. The control unit performs calculation according to a method of measuring by sucking the toner in an area A on the photoconductive drum 11c shown in FIG. 6A by an amount corresponding to a surface area Sa (cm²), measuring a weight difference ma (mg) of the photoconductive drum 11c before and after the suction, and controlling the amount of adhered toner Ml to satisfy M1=ma/Sa.

The control unit also measures an amount of adhered toner M2 (mg/cm²) formed on the photoconductive drum 11c after the transfer of the solid image of Cyan onto the intermediate transfer belt 15. The control unit performs calculation by sucking the toner in an area B of the photoconductive drum 11c shown in FIG. 6A by an amount corresponding to a surface area Sb (cm²), measuring a weight difference mb (mg) of the photoconductive drum 11c before and after the suction, and controlling the amount of adhered toner M2 to satisfy M2=mb/Sb.

Therefore, the transfer efficiency of the single color C is expressed by TRc=(M1−M2)/M1×b100(%).

<Survival Rate from Reverse Transfer in C Station: RTRc>

Subsequently, a method of measuring the survival rate from reverse transfer in C station will be described. The color image forming apparatus 101 prints a solid image of Magenta onto the intermediate transfer belt 15 in the second station. In the M station, the control unit adjusts the developing bias to be applied between the developing device 13b and the photoconductive drum 11b so that the amount of adhered toner of the solid image formed on the photoconductive drum 11b becomes 0.43-0.48 (mg/cm²). The control unit also adjusts the transfer bias of the M station so that the transfer efficiency of the M station becomes 90% or more.

FIG. 6B is a drawing showing actions of the respective members in the C station. The control unit suddenly stops the respective members of the C station while the solid image of Magenta formed on the intermediate transfer belt 15 passes the primary transfer section of the C station.

Here, the control unit measures an amount of adhered toner M3 (mg/cm²) formed on the intermediate transfer belt 15 before entering the C station. The control unit performs calculation according to a method of measuring by sucking the toner in an area C of the photoconductive drum 11c shown in FIG. 6B by an amount corresponding to a surface area Sc (cm²), measuring a weight difference mc (mg) of the photoconductive drum 11c before and after the suction, and controlling the amount of adhered toner M3 to satisfy M3=mc/Sc.

The control unit also measures an amount of adhered toner M4 (mg/cm²) in an area D reversely transferred to the photoconductive drum 11c of the C station. The control unit performs calculation according to a method of measuring by sucking the toner in the area D of the photoconductive drum 11c shown in FIG. 6A by an amount corresponding to a surface area Sd (cm²), measuring a weight difference md (mg) of the photoconductive drum 11c before and after the suction, and controlling the amount of adhered toner M4 to satisfy M4=md/Sd.

Therefore, the single-color survival rate from reverse transfer in the C station is expressed by RTRc=(M3−M4)/M3×100(%).

### <Three-Color-Registration Transfer Efficiency: TR3>

Subsequently, a method of measuring a three-color-registration transfer efficiency TR3 in the C station will be described. The color image forming apparatus 101 prints a solid image of Yellow, a solid image of Magenta, and a solid image of Cyan in the first station, in the second station, and in the third station respectively onto the intermediate transfer belt 15 in three-color-registration. In the Y station, the control unit adjusts the developing bias to be applied between the developing device 13a and the photoconductive drum 11a so that the amount of adhered toner of the solid image formed on the photoconductive drum 11a becomes 0.45-0.50 (mg/cm²). The control unit also adjusts the transfer bias of the Y station so that the transfer efficiency of the Y station becomes 90% or more.

Subsequently, in the M station, the control unit adjusts the developing bias to be applied between the developing device 13b and the photoconductive drum 11b so that the amount of adhered toner of the solid image formed on the photoconductive drum 11b becomes 0.43-0.48 (mg/cm²). The control unit also adjusts the transfer bias of the M station so that the transfer efficiency of the M station becomes 90% or more.

Subsequently, in the C station, the control unit adjusts the developing bias to be applied between the developing device 13c and the photoconductive drum 11c so that the amount of adhered toner of the solid image formed on the photoconductive drum 11c becomes 0.4-0.45 (mg/cm²). The control unit also adjusts the transfer bias of the C station so that the transfer efficiency of the C station becomes 90% or more.

FIG. 6C is a drawing showing actions of the respective members in the C station. The control unit suddenly stops the respective components in the C station while the solid image formed on the photoconductive drum 11c in the C station is being transferred to the intermediate transfer belt 15.

Here, the control unit measures an amount of adhered toner M5 (mg/cm²) formed on the photoconductive drum 11c before transferring the solid image in Cyan onto the intermediate transfer belt 15. The control unit performs calculation according to a method of measuring by sucking the toner in an area E of the photoconductive drum 11c shown in FIG. 6C by an amount corresponding to a surface area Se (cm²), measuring a weight difference me (mg) of the photoconductive drum 11c before and after the suction, and controlling the amount of adhered toner M5 to satisfy M5=me/Se.

The control unit also measures an amount of adhered toner M6 (mg/cm²) formed on the photoconductive drum 11c after transferring the solid image in Cyan onto the intermediate transfer belt 15. The control unit performs calculation according to a method of measuring by sucking the toner in an area F of the photoconductive drum 11c shown in FIG. 6C by an amount corresponding to a surface area Sf (cm²), measuring a weight difference mf (mg) of the photoconductive drum 11c before and after the suction, and controlling the amount of adhered toner M6 to satisfy M6=mf/Sf.

Therefore, the three-color-registration transfer efficiency is expressed by

TR3=(M5−M6)/M5×100(%).

As shown in FIGS. 4A, 4B, and 4C which are the results of measurement of the TRc, RTRc, and TR3 described above by changing the transfer bias in the C station, if the resistance of the intermediate transfer belt 15 is increased, the adequate transfer bias is shifted to a rather high level. The maximum transfer efficiencies of the single color of Cyan exceed 95% in all the intermediate transfer belts 15. If the resistance values of the intermediate transfer belts 15 are increased, the single color survival rate from reverse transfer tends to be improved. The belt C achieves 90% or more single color transfer efficiency and also 90% or more single color survival rate from reverse transfer.

However, as shown in FIG. 4C, if the resistance values of the intermediate transfer belts 15 are increased, the transfer bias which achieves a good three-color-registration transfer efficiency is increased to a significantly high level. Therefore, a bias area which satisfies the single-color transfer efficiency, the single-color survival rate from reverse transfer, and the three-color-registration transfer efficiency (90% or more for all of them) does not exist in any one of the belt A, the belt B, and the belt C.

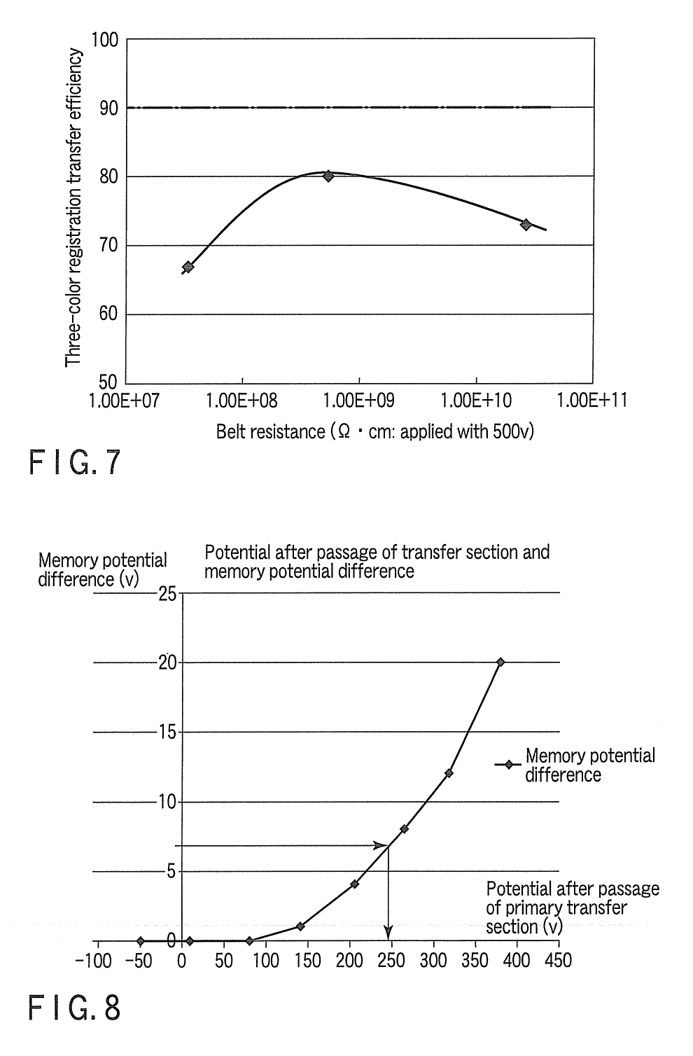

FIG. 7 is a graph in which a lateral axis represents the volume resistivity of the intermediate transfer belt 15, and a vertical axis represents the maximum value of the three-color-registration transfer efficiency within a transfer bias range which is able to achieve 90% or more single-color survival rate from reverse transfer. As shown in FIG. 7, the single-color survival rate from reverse transfer reaches the maximum level near a point of 5×10⁸ Ω·cm (applied with 500V). However, there is no resistance value of the intermediate transfer belt 15 which satisfies both 90% or more single-color survival rate from reverse transfer and 90% or more single-color transfer efficiency and the three-color-registration transfer efficiency.

### <Transfer Memory>

The potential of the photoconductive drum 11a after the passage through the primary transfer section might be inverted to a positive polarity by the reception of a positive charge applied from the intermediate transfer belt 15. If the electrostatic charger 17a is a corona charging device or a contact charging device which applies an AC bias, the charging performance with respect to the photoconductive drum 11a is high. The electrostatic charger 17a is easily able to charge the photoconductive drum 11a to a predetermined negative potential. However, since the electrostatic charger 17a is a DC charge roller in this embodiment, the charging performance with respect to the photoconductive drum 11a is low. Therefore, if the photoconductive drum 11a is charged positively to a significantly large extent in the primary transfer section, the electrostatic charger 17a cannot charge the photoconductive drum 11a to a predetermined negative potential.

The color image forming apparatus 101 shown in FIG. 2 is provided with a surface electrometer, not shown, at a position after the passage through the primary transfer section. Then, the transfer bias was changed, and the potential of the photoconductive drum 11a after the passage through the primary transfer section and the potential of the photoconductive drum 11a after passage through the electrostatic charger 17a were measured. The measurement was performed by turning OFF the transfer of the developed image to the intermediate transfer belt 15 from the photoconductive drum 11a, and adjusting the charge bias so that the potential of the photoconductive drum 11a becomes the preset potential. Then, the transfer bias of the photoconductive drum 11a for a period corresponding to four turns thereof was turned ON to provide a transfer charge thereto, and then the post-transfer potential and the charged potential were measured.

FIG. 8 is a graph of the result of measurement described above, in which the lateral axis represents the potential of the photoconductive drum 11a after the passage through the primary transfer section and the vertical axis represents the difference between the preset potential and the potential that the photoconductive drum 11a is actually charged (ΔV: transfer memory potential difference). If the memory potential difference ΔV is 7V or higher, the concentration difference is 0.05 or more in the half-tone image, which is a level that the human eye can recognize as a difference in image concentration. As is understood from FIG. 8, the potential of the photoconductive drum 11a after the passage of the primary transfer section should not exceed +250V in order to keep the memory potential difference ΔV to a value smaller than 7V.

In the measurement descried above, the potential after the passage through the primary transfer section was changed by changing the transfer bias while ignoring the transfer efficiency. However, under the actual usage conditions, the transfer bias is adjusted to an adequate transfer bias at which the satisfactory transfer performance is obtained. However, if the value of resistance (volume resistivity×thickness) of the intermediate transfer belt 15 is changed, the potential after the passage through the primary transfer section is changed even the transfer bias is adjusted to the adequate transfer bias.

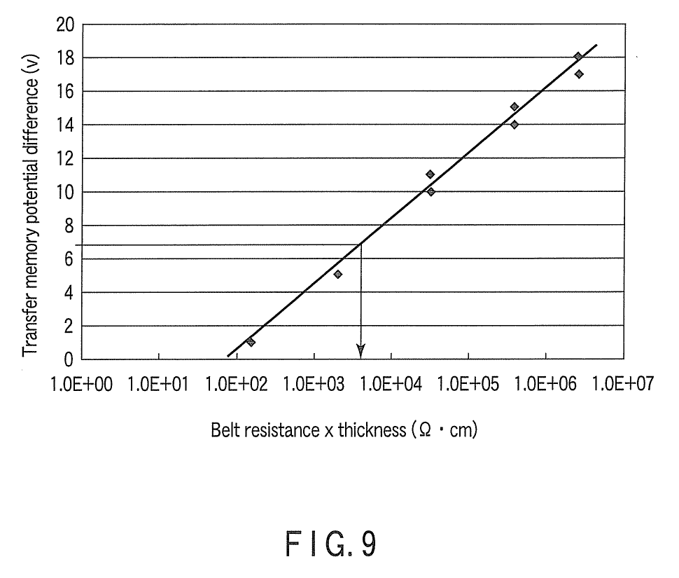

FIG. 9 is a graph in which the lateral axis represents the volume resistivity×thickness of the belt, and the vertical axis represents the ΔV: transfer memory potential difference. From the graph shown in FIG. 9, it is understood that it is essential only that the following conditional expression is satisfied in order to prevent the transfer memory;

ρ₅₀₀·d>3.0×10³ (Ω·m²)

### (3) In the Case of the Cleanerless Process

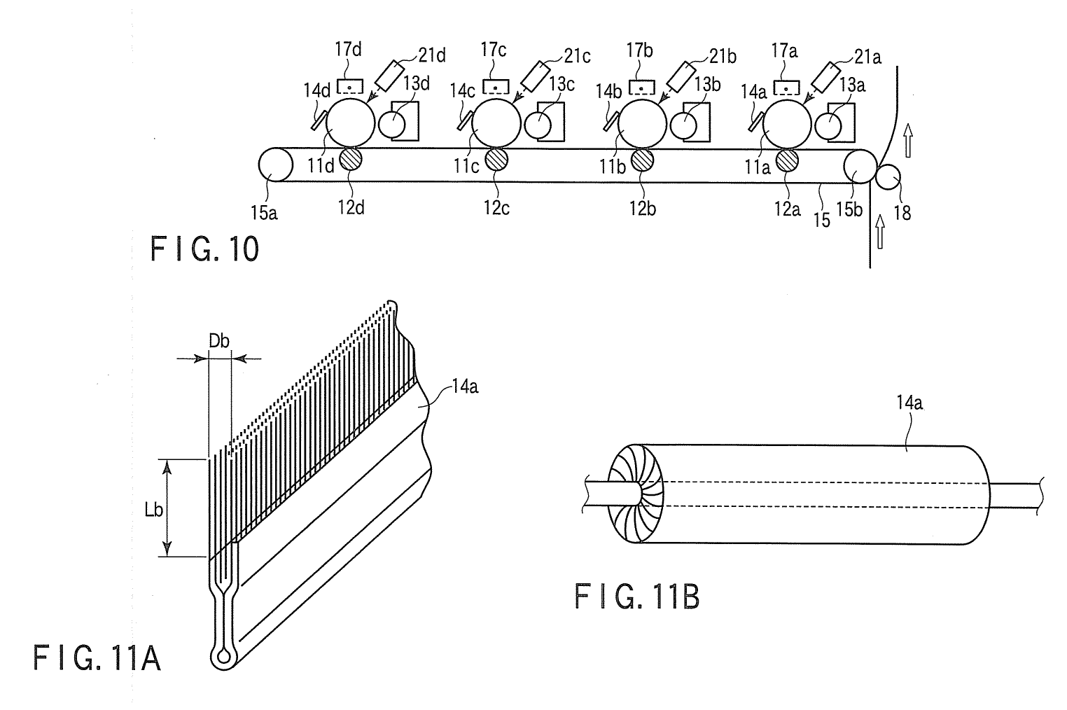

FIG. 10 is a schematic drawing showing an interior structure of the color image forming apparatus 101 in which the cleanerless process is applied viewed from the front. Here, the Y station, the M station, the C station, and the Bk station are shown in an enlarged scale. The same configurations as those in the color image forming apparatus 101 in FIG. 2 are designated by the same reference numerals, and the description thereof will be omitted.

In the Y-station, a brush-like blending member 14a is provided instead of the cleaner 16a in the color image forming apparatus 101 in FIG. 2. In the same manner, a blending member 14b is provided in the M station, a blending member 14c is provided in the C station, and a blending member 14d is provided in the Bk station.

After the visualized image is transferred to the intermediate transfer belt 15, the blending member 14a blends residual toner remaining on the surface of the photoconductive drum 11a or the like after the passage of the photoconductive drum 11a through the primary transfer section at a position before the electrostatic charger 17a charges the photoconductive drum 11a. Then, the electrostatic charger 17a charges the photoconductive drum 11a and repeats the charging process.

The untransferred toner passed through the electrostatic charger 17a was already subjected to the charging process, it is charged to the same polarity as the charged potential of the photoconductive drum 11a (the negative polarity in this embodiment). If the untransferred toner on the photoconductive drum 11a reaches the developing device 13a, the developing device 13a performs so-called a parallel cleaning with the development, that is, a new toner is developed over the untransferred toner on the photoconductive member in the image portion of the photoconductive drum 11a, and the untransferred toner in the non-image portion is collected to the developing roller side. Accordingly, even though the cleaner 16a such as a blade is not provided on the photoconductive drum 11a of the image forming unit 1, the electrophotographic process of the image forming unit 1 in the first stage (Y station) can be preformed continuously.

The configuration from the second stage (M station) to the fourth stage (Bk station) of the image forming unit 1 thereafter is the same as that descried in conjunction with the color image forming apparatus 101 in FIG. 2. In the intermediate transfer belt 15, the four image forming stations are provided, and a color image is formed by primarily transferred registered image.

The backup roller 15c and the transfer device 18 are the same as those described in conjunction with the color image forming apparatus 101 shown in FIG. 2. The blending members 14a, 14b, 14c, and 14d here blend patterns of the untransferred toner on the photoconductive drums 11a, 11b, 11c, and 11d which was not transferred even by passing through the primary transfer section and the reversely transferred toner which is transferred reversely to the photoconductive drums 11b, 11c, and 11d from the M station in the second stage onward. In general, the untransferred toner has a negative polarity although it depends on the transfer bias. The reversely transferred toner has a positive polarity, which is the opposite polarity therefrom, in many cases.

Subsequently, a configuration of the blending member 14a will be described. The configurations of the blending members 14b, 14c, and 14d are the same as that of the blending member 14a. The blending member 14a is, for example, a fixed-type brush. The blending member 14a has bristles having a length Lb of 2 to 20 mm, a thickness in width Db of 1 to 10 mm, a fineness of 1 to 10 deniers, a resistance of 1×10⁴ to 1×10¹⁰Ω. The blending member 14a generates an electric field with respect to the surface of the photoconductive drum 11a by being applied with a predetermined bias by a high-voltage power source, not shown, thereby blending the untransferred toner. The blending member 14a is biased roughly by a range from +200 to 1000V. The surface of the photoconductive drum 11a after the transfer of the toner to the intermediate transfer belt 15 in the primary transfer section is biased roughly by a range from −50 to +100V by the influence of the transfer. Therefore, the blending member 14a attracts the untransferred toner on the surface of the photoconductive drum 11a most part of which has a negative polarity once. However, the blending member 14a then is positively charged by a charge injection or a discharge, and discharges the untransferred toner gradually. Therefore, the blending member 14a blends the pattern of the untransferred toner on the surface of the photoconductive drum 11a and eliminates the same. The photoconductive drum 11a then assumes a negative polarity again when passing through the electrostatic charger 17a such as the corona charger or the like. Then, the untransferred toner on the surface of the photoconductive drum 11a is collected by the developing device 13a in the next charging.

The blending member 14a is not limited to the fixed-type brush with respect to the photoconductive drum 11a shown in FIG. 11A, and may be a roller-type shown in FIG. 11B. The roller-type blending member 14a may be a conductive sponge roller or a brush roller.

The color image forming apparatus 101 in which the cleanerless process is applied as shown in FIG. 10 basically collects the untransferred toner to the developing device 13a for reuse. Therefore, in a range in which the amount of the untransferred toner does not increase too much, the problem of generation of the waste toner does not occur as long as the transfer efficiency is 80% or more. However, since the color of the toner reversely transferred to the photoconductive drum 11a is different from the toner in the developing device 13a in which the corresponding toner is to be collected, a mixed color is generated in the developing device 13a, so that a problem might occur in color reproducibility of the image. In other words, the color reproducibility due to the mixed color caused by the reversely transferred toner rises a new issue.

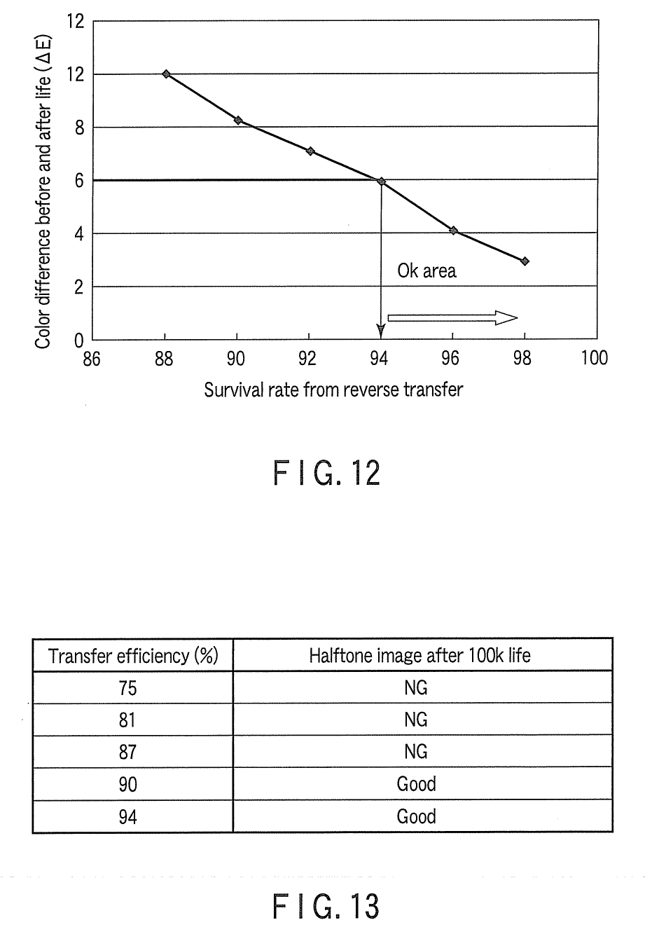

FIG. 12 is a graph showing the color difference of an image in a single color of magenta printed at a surface ratio of 10%, subjected to a life test at a printing ratio of 5% in the C station, and printed a single color of Cyan on 100 k sheets from the initial image. The transfer bias is adjusted, and the life test is conducted by changing the survival rate from reverse transfer of the single color. As shown in FIG. 12, if the survival rate from reverse transfer of a single color falls to 94% or below, the color difference ΔE before and after the life test becomes 6 or higher, which is a problem. Since the color change is fatal problem in the color image forming apparatus 101 in which the cleanerless process is applied, it is essential to secure 94% as the survival rate from reverse transfer of a single color.

In contrast, when there is a significant amount of untransferred toner on the surface of the photoconductive drum 11a, the untransferred toner accumulates on the blending member 14a. If the blending member 14a is continuously kept in contact with the surface of the photoconductive drum 11a during operation for a long time in this state, the untransferred toner is adhered to the surface of the photoconductive drum 11a gradually due to a sliding friction between the blending member 14a and the surface of the photoconductive drum 11a. Then, on the surface of the photoconductive drum 11a, the untransferred toner is secured, and so-called a photoconductor filming occurs.

FIG. 13 is a drawing showing a result of the printing life test with 6% of Cyan using the belt B in the color image forming apparatus 101 in which the cleanerless process is applied. Here, FIG. 13 shows a state of occurrence of the filming on the surface of the photoconductive drum 11a after the printing on 100 k sheets at various transfer efficiencies by changing the transfer bias. If the filming occurs on the surface of the photoconductive drum 11a, unevenness is resulted in the halftone image. Therefore, the evaluation is performed on the basis of the level of the unevenness of the halftone image.

In order to prevent the occurrence of the filming on the surface of the photoconductive drum 11a, the single-color transfer efficiency and the three-color-registration transfer efficiency must be 90% or more. In other words, in order to maintain the image concentration in the color image forming apparatus 101 in which the cleanerless process is applied and preventing the problem of color reproducibility such as incomplete image or color mixture due to filming from occurring, 90% or more of the single-color transfer efficiency and the three-color-registration transfer efficiency and 94% or more of the single-color survival rate from reverse transfer must be secured.

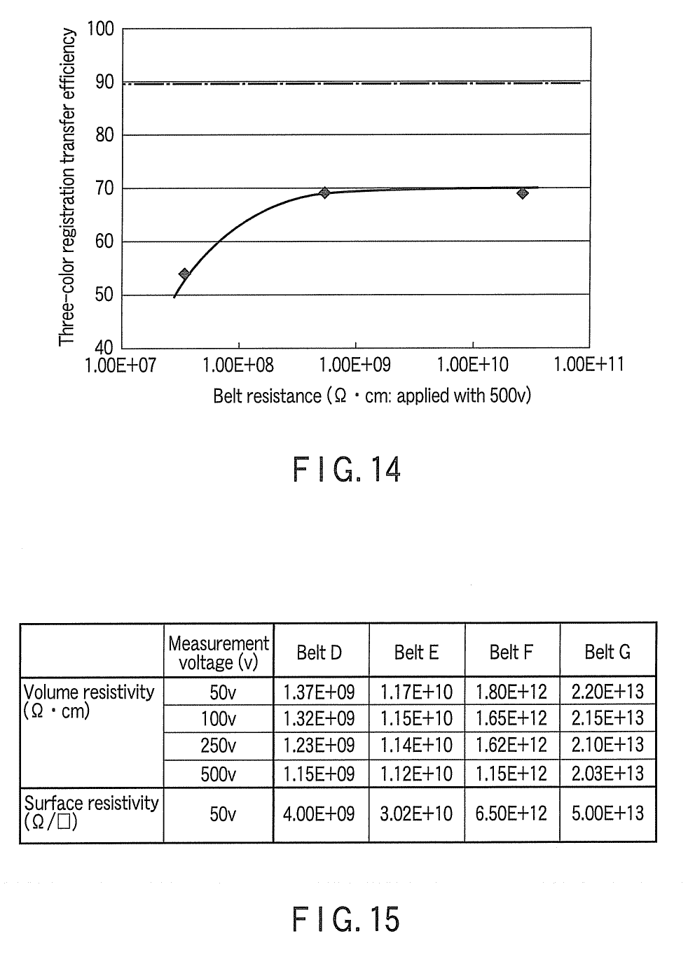

FIG. 14 is a graph in which a lateral axis represents the volume resistivity of the intermediate transfer belt 15, and a vertical axis represents the maximum value of the three-color-registration transfer efficiency within a transfer bias range which is able to achieve 94% or more single-color survival rate from reverse transfer. A resistance of the belt used for the intermediate transfer belt 15 which realizes both 94% or more of the single-color survival rate from reverse transfer and 90% or more of the three-color-registration transfer efficiency does not exist.

The maximum value of the three-color-registration transfer efficiency is only 70% or less with the transfer bias which makes the single-color transfer remaining ratio 94% or more irrespective of any one of the above-described belts A to C is used as the intermediate transfer belt 15. In other words, an adequate value as the value of resistance of the belt which is able to achieve both 90% or more of the single-color transfer efficiency and the three-color-registration transfer efficiency and 94% or more of the single-color survival rate from reverse transfer does not exist among the belt A to C.

Therefore, it is important to select (1) a resistance of the intermediate transfer belt 15 which satisfies the single-color survival rate from reverse transfer and (2) a resistance of the intermediate transfer belt 15 which achieves the three-color-registration transfer efficiency. The resistance in (1) means a resistance behavior of the intermediate transfer belt 15 at a transfer nip portion. The resistance in (2) is a resistance behavior of the intermediate transfer belt 15 after the passage through the nip. A voltage applied to the intermediate transfer belt 15 at the transfer nip portion is 500V. In contrast, the potential difference between the upper surface and the lower surface of the intermediate transfer belt 15 after the passage through the transfer nip portion is several tens of volts.

The resin belt having carbon dispersed therein demonstrates different values of resistance depending on the voltage applied to the resin belt as shown in FIG. 5. In other words, the resistance of the resin belt after the passage through the transfer nip portion is increased even through it is low in the area of the transfer nip portion. If the resistance of the resin belt after the passage through the transfer nip portion is high, the speed of disappearance of the negative (−) charge which hinder the transfer accumulated on the surface of the resin belt is lowered, and hence there may arise problems in multiple registration transfer efficiency.

It is considered that the single-color survival rate from reverse transfer in (1) has a correlation with the value of the volume resistivity ρ₅₀₀ measured when applying a voltage of 500V to the resin belt. It is also considered that the multiple registration transfer efficiency in (2) has a correlation with the value of the volume resistivity ρ₅₀ when applying a voltage of 50V to the resin belt. Therefore, the reason why the value of resistance which satisfies all the single-color transfer efficiency, the three-color-registration transfer efficiency, and the single-color survival rate from reverse transfer in the belt A, the belt B, and the belt C as single layer belts formed by dispersing carbon therein shown in FIG. 5 does not exist might be affected by a large difference between ρ₅₀₀ and ρ₅₀. The degree of variations in resistance of the resin belt with respect to the applied voltage differs depending on the type of the base material or carbon. However, the same tendency is demonstrated among the types formed of the electroconductive material.

If the value of resistance of the belt achieved by applying 500V to the intermediate transfer belt 15 is lower than the value of resistance of the belt achieved by applying 50V to the same, the optimization of the belt resistance is difficult. FIG. 15 is a table showing the resistance characteristics of four types of belts; a rubber belt D, a rubber belt E, a rubber belt F, and a rubber belt G adjusted in resistance by changing the composition of rubber instead of dispersing carbon for each of the measuring voltages. Since the rubber belt D, the rubber belt E, the rubber belt F, and the rubber belt G have a non-electro (ion) conductivity, the value of volume resistivity does not fluctuate according to the measuring voltages. The environment of the measurement is a temperature of 23° C. and a humidity of 50%.

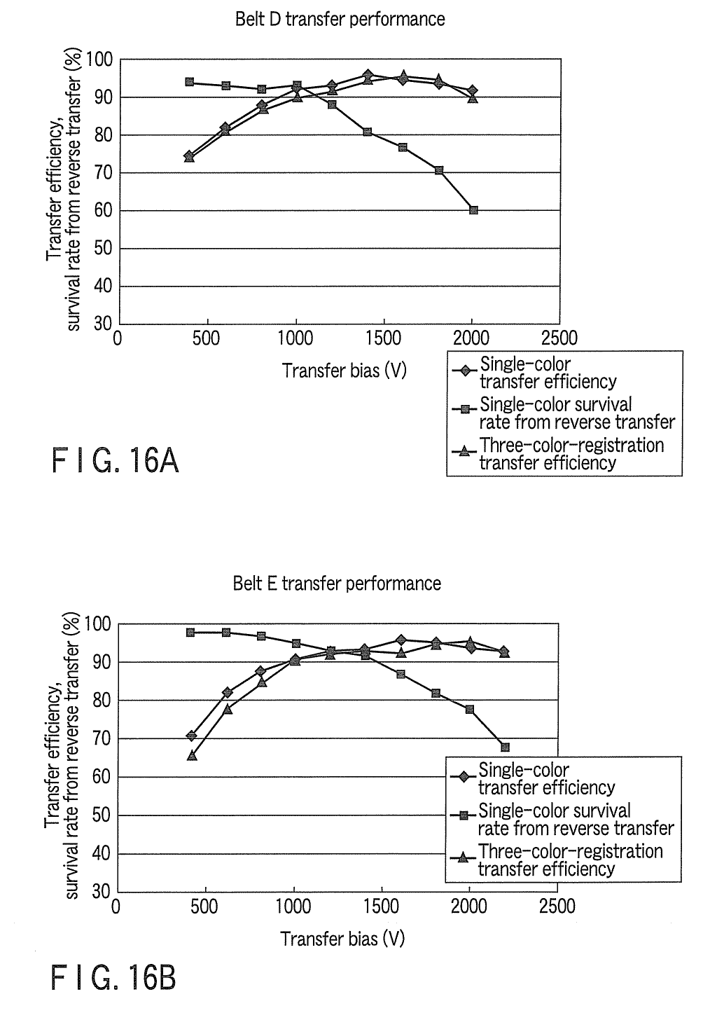

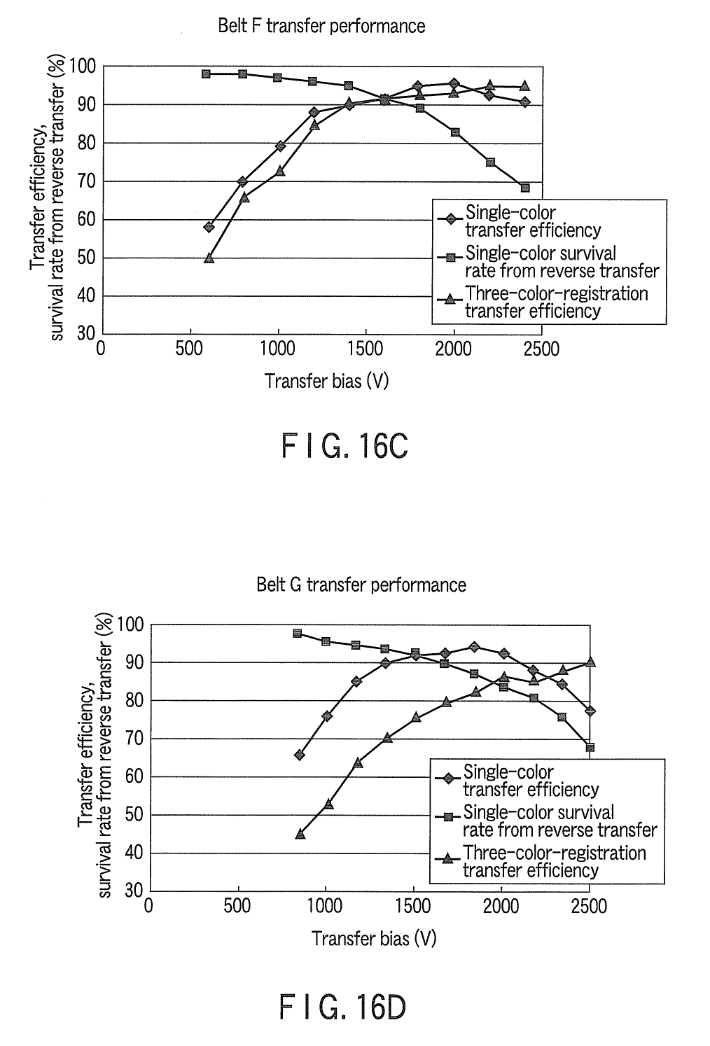

The thicknesses of the rubber belt D, the rubber belt E, the rubber belt F, and the rubber belt G are all 500 μm. FIG. 16A is a graph showing the results of evaluations of the single-color transfer efficiency, the three-color-registration transfer efficiency, and the single-color survival rate from reverse transfer when the rubber belt D is used as the intermediate transfer belt 15 of the color image forming apparatus 101 shown in FIG. 2. In the same manner, FIG. 16B is a graph showing a case of the rubber belt E, FIG. 16C is a graph showing a case of the rubber belt F, and FIG. 16D is a graph showing a case of the rubber belt G. As shown in FIG. 16A, FIG. 16B, FIG. 16C, and FIG. 16D, the single-color transfer efficiency, the three-color-registration transfer efficiency, and the single-color survival rate from reverse transfer are characteristics relating to the value of resistance in the direction of thickness of the intermediate transfer belt 15, it is considered to be correlated with the product of the value of volume resistivity and the belt thickness of the intermediate transfer belt 15.

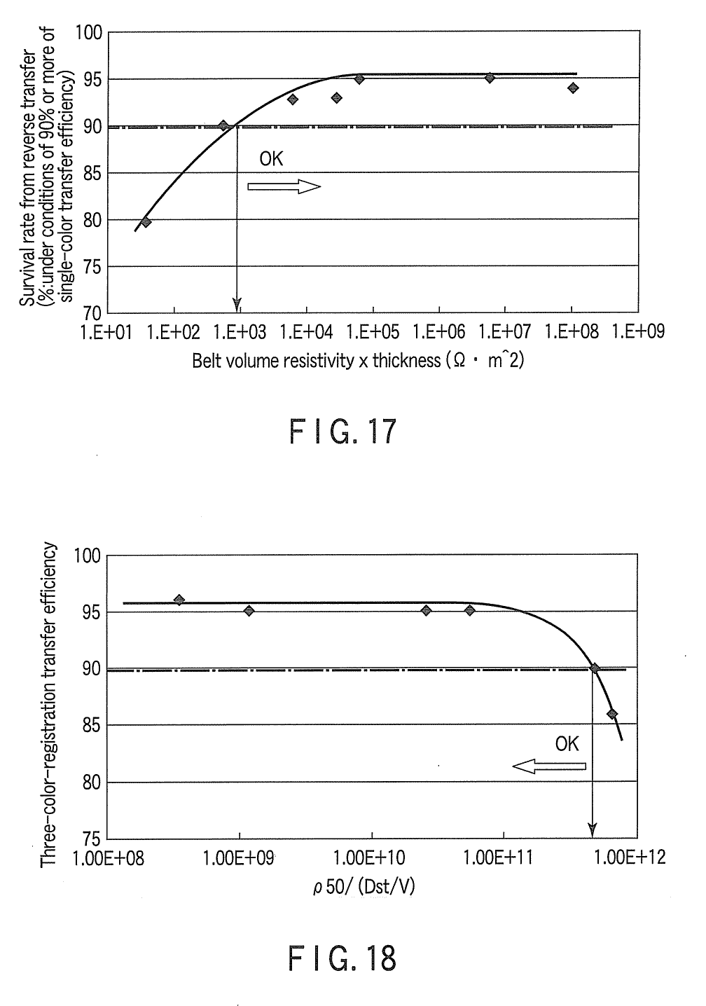

The voltage to be applied to the intermediate transfer belt 15 at the transfer nip portion is considered to be several hundreds volts. FIG. 17 is a graph in which the lateral axis represents the product (ρ₅₀₀·d) of the belt volume resistivity ρ₅₀₀ (Ω·m) and the belt thickness d (m), and the vertical axis represents the maximum value of the single-color survival rate from reverse transfer within a range of transfer bias in which the single-color transfer efficiency is 90% or more. Seven plots represent data of the belts A to G.

As shown in FIG. 17, if the product of the volume resistivity and the thickness of the intermediate transfer belt 15 is 1.0×10³ (Ω·m²) or larger, 90% of the single-color transfer efficiency and 90% of the single-color survival rate from reverse transfer are both satisfied. The belts A to C are polyimide belts having electroconductivity with a thickness of 100 μm. The belts D to G are rubber belts having non-electroconductivity with a thickness of 500 μm. The results of these seven belts A to G are shown in one graph. Therefore, FIG. 17 indicates that 90% or more of the single-color transfer efficiency and 90% or more of the single-color survival rate from reverse transfer are both satisfied irrespective of the property whether the intermediate transfer belt 15 is non-electroconductive or electroconductive, the belt thickness, and the belt material if these conditions are satisfied.

In contrast, the three-color-registration transfer efficiency seems to relate to the disappearing performance of the belt charge in a distance between the stations. In other words, it seems to have a correlation with a ratio between the time constant of the belt and the station-to-station moving time (Dst/V). Time constant is τ=ε·ε₀·ρ, and is proportional to the belt ratio resistance. Since the potential difference between the upper surface and the lower surface of the intermediate transfer belt 15 after the passage through the transfer nip portion is approximately 50V (several tens of volts to 100V), it is appropriate to calculate the belt ratio resistance here by a value measured with an applied voltage of 50V.

From the description given above, it is considered that the three-color-registration transfer efficiency relates to ρ₅₀/(Dst/V). FIG. 18 is a graph in which a lateral axis represents ρ₅₀/(Dst/V), and a vertical axis represents the maximum value of the three-color-registration transfer efficiency within a transfer bias range which is able to achieve 90% or more single-color transfer efficiency. Seven plots represent data of the belts A to G. As shown in FIG. 18, if (Dst: station-to-station distance (m), V: process velocity (m/sec)) ρ₅o/(Dst/V) does not exceed 4.0×10¹¹ (Ω·m/sec), 90% of the single-color transfer efficiency and 90% of the three-color-registration transfer efficiency are realized.

The color image forming apparatus 101 shown in FIG. 2 hasV=240 mm/sec=0.24 m/sec, and the station-to-station distance Dst=80 mm=0.08 m.

The belts A to C are polyimide belts having electroconductivity with a thickness of 100 μm. The belts D to G are rubber belts having non-electroconductivity with a thickness of 500 μm. The results of these seven belts A to G are shown in one graph. Therefore, FIG. 18 indicates that 90% or more of the single-color transfer efficiency and 90% or more of the three-color-registration transfer efficiency are both satisfied irrespective of the property whether the intermediate transfer belt is non-electroconductive or electroconductive, the belt thickness, and the belt material if these conditions are satisfied.

From the description above, the following relation is satisfied.

### Conditional Expression for Preventing Occurrence of Image Blur

Belt surface resistivity σ₅₀>2.0×10¹⁰ (Ω/□) (1)

Conditional Expression for Achieving 90% for Both Single-Color Transfer Efficiency and Single-Color Survival Rate from Reverse Transfer

ρ₅₀₀·d>1.0×10³ (Ω·m²) (2)

Conditional Expression for Realizing 90% of Single-Color Transfer Efficiency and 90% of Three-color-Registration Transfer Efficiency with the same Bias

ρ₅₀/(Dst/V)<4.0×10¹¹ (Ω·m/sec) (3)

If the three conditional expressions of (1), (2), and (3) shown above are satisfied, the image blur does not occur, and 90% or more of the single-color transfer efficiency and the three-color-registration transfer efficiency and 90% or more of the single-color survival rate from reverse transfer are both satisfied.

d: belt thickness (m)

Dst: station-to-station distance (m)

V: velocity of belt movement (m/sec)

p: belt volume resistivity (Ω·m); measured with an applied voltage of 500V

From among the belts A to G shown in FIG. 5 and FIG. 15, only the belt E and the belt F satisfy the conditional expressions (1), (2), and (3). The belt D does not satisfy the expression (1) and the image blur occurs, so that it is not good. Therefore, the belts which achieve 90% or more of the single-color transfer efficiency and the three-color-registration transfer efficiency and 90% or more of the single-color survival rate from reverse transfer are only the belt E and the belt F.

Here, the conditional expression for keeping the transfer memory potential difference ΔV to be lower than 7V for preventing the transfer memory described above;

ρ₅₀₀·d>3.0×10³ (Ω·m²) (2′)

is employed.

If the four conditional expressions of (1), (2), (3), and (2′) are satisfied, the blur of the image is prevented, and 90% or more of the single-color transfer efficiency and the three-color-registration transfer efficiency and 90% or more of the survival rate from reverse transfer are both satisfied. Also, a high-quality image which is satisfactory in image concentration and color reproducible range and has no halftone concentration difference due to the transfer memory is obtained. Since the waste toner box is rarely fill up to the top, workability of the user and availability of the apparatus are not lowered.

Since the expression (2) is automatically satisfied if the condition of the expression (2′) is satisfied, it is essentially only that the expressions (1), (3), and (2′) are satisfied.

From among the belts A to G shown in FIG. 5 and FIG. 15, only the belt E and the belt F satisfy the conditional expressions (1), (3), and (2′). Therefore, the belts which do not cause the image blur, achieve 90% or more of the single-color transfer efficiency and the three-color-registration transfer efficiency and 90% or more of the survival rate from reverse transfer are only the belt E and the belt F.

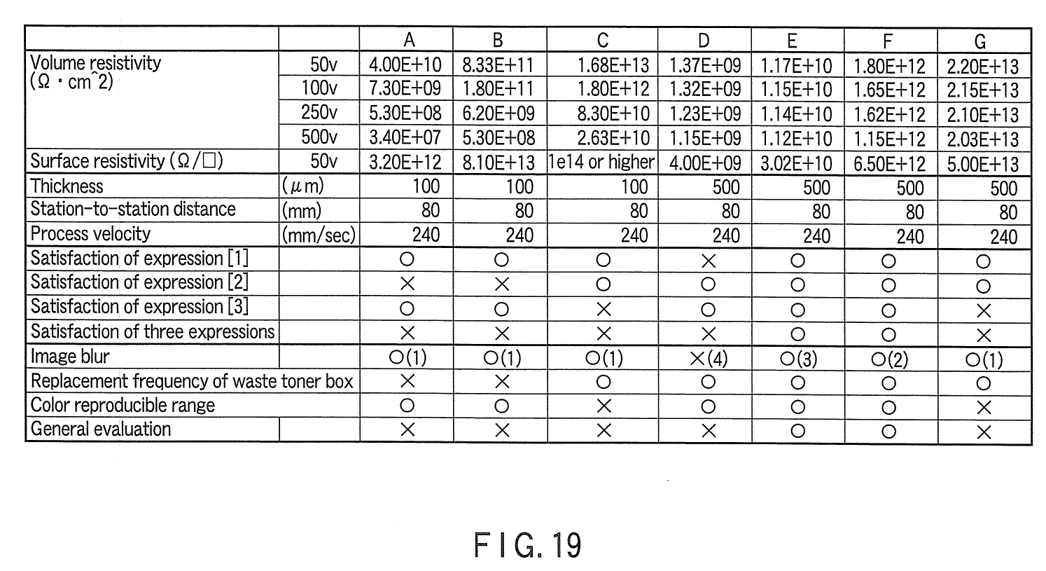

FIG. 19 shows results of printing test conducted using the belts A to G, respectively. In the color image forming apparatus 101 using the belt E and the belt F as the intermediate transfer belt 15, the problem of overflow of the waist toner box within a predetermined life, or problems of insufficient image concentration or change in color do not occur, and a satisfactory image is obtained throughout the life.

In contrast, in the color image forming apparatus 101 in which the cleanerless process is applied as shown in FIG. 10, the problems of the color mixture or the filming cannot be solved unless 94% of the single-color survival rate from reverse transfer and 90% or more of the single-color transfer efficiency and the three-color-registration transfer efficiency are achieved as described above.

FIGS. 4A to 4C and FIGS. 16A to 16D show results of measurement of the single-color transfer efficiency of Cyan, three-color-registration transfer efficiency, and single-color survival rate from reverse transfer of Cyan using the belts A to G in the color image forming apparatus 101 in which the cleanerless process is applied as shown in FIG. 10. The environment of the measurement is a temperature of 23° C. and a humidity of 50%. The single-color transfer efficiency, the three-color-registration transfer efficiency, and the single-color survival rate from reverse transfer are characteristics relating to the value of resistance in the direction of thickness of the intermediate transfer belt 15, it is considered to be correlated with the product of the value of volume resistivity and the belt thickness of the intermediate transfer belt 15.

Also, the voltage to be applied to the intermediate transfer belt 15 at the transfer nip portion is considered to be several hundreds volts.

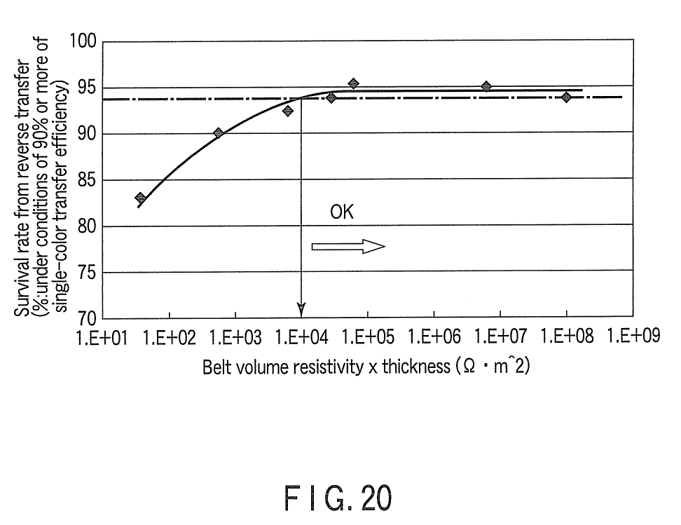

FIG. 20 is a graph in which the lateral axis represents the product (ρ₅₀₀·d) of the belt volume resistivity ρ₅₀₀ (Ω·m) and the belt thickness d (m), and the vertical axis represents the maximum value of the single-color survival rate from reverse transfer within a range of transfer bias in which the single-color transfer efficiency is 90% or more. Seven plots represent data of the belts A to G. As shown in FIG. 20, the product of the volume resistivity and the thickness of the intermediate transfer belt 15 is 1.0×10³ (Ω·m²) or larger, 90% of the transfer efficiency and 94% of the survival rate from reverse transfer are both satisfied.

In contrast, the three-color-registration transfer efficiency seems to relate to the disappearing performance of the belt charge in a distance between the stations. In other words, it seems to have a correlation with a ratio between the time constant of the belt and the station-to-station moving time (Dst/V). Time constant is τ=ε·ε₀·ρ, and is proportional to the belt ratio resistance. Since the potential difference between the upper surface and the lower surface of the intermediate transfer belt 15 after the passage through the transfer nip portion is about 50V (several tens of V to 100V), it is adequate to calculate the belt ratio resistance here by a value measured with an applied voltage of 50V.

From the description given above, it is considered that the three-color-registration transfer efficiency relates to ρ₅₀/(Dst/V). FIG. 18 is a graph in which a lateral axis represents ρ₅₀/(Dst/V), and a vertical axis represents the maximum value of the three-color-registration transfer efficiency within a transfer bias range which is able to achieve 90% or higher single-color transfer efficiency. Seven plots represent data of the belts A to G. As shown in FIG. 18, if (Dst: station-to-station distance (m), V: process velocity (m/sec))ρ₅₀/(Dst/V) does not exceed 4.0×10¹¹ (Ω·m/sec), 90% of the single-color transfer efficiency and 90% of the three-color-registration transfer efficiency are realized. The color image forming apparatus 101 shown in FIG. 2 has V=240 mm/sec=0.24 m/sec, and the station-to-station distance Dst=80 mm=0.08 m.

From the description above, the following relation is satisfied.

### Conditional Expression for Preventing Occurrence of Image Blur

It is the same as the color image forming apparatus 101 having the cleaners 16a to 16d shown in FIG. 2. If the conditional expression is the same, the same expression numeral is provided.

Belt surface resistivity ρ₅₀>2.0×10¹⁰ (Ω/□) (1)

Conditional Expression for Realizing 90% of Single-Color Transfer Efficiency and 94% of Single-Color Survival Rate from Reverse Transfer

ρ₅₀₀·d>1.0×10⁴ (Ω·m²) (4)

Conditional Expression for Realizing 90% of Single-Color Transfer Efficiency and 90% of Three-Color-Registration Transfer Efficiency with the Same Bias

ρ₅₀/(Dst/V)<4.0×10¹¹ (Ω·m/sec) (3)

If the three conditional expressions of (1), (4), and (3) shown above are satisfied, the image blur does not occur, and 90% or more of the single-color transfer efficiency and the three-color-registration transfer efficiency and 94% or more of the single-color survival rate from reverse transfer are both satisfied. With the color image forming apparatus 101, a satisfactory image without image defective due to the photoconductor filming or color mixture due to the reverse transfer is obtained.

From among the belts A to G shown in FIG. 5 and FIG. 14, only the belt E and the belt F satisfy the conditional expressions (1), (4), and (3). Therefore, the belts which do not cause the image blur, achieve 90% or more of the single-color transfer efficiency and the three-color-registration transfer efficiency and 94% or more of the single-color survival rate from reverse transfer are only the belt E and the belt F.

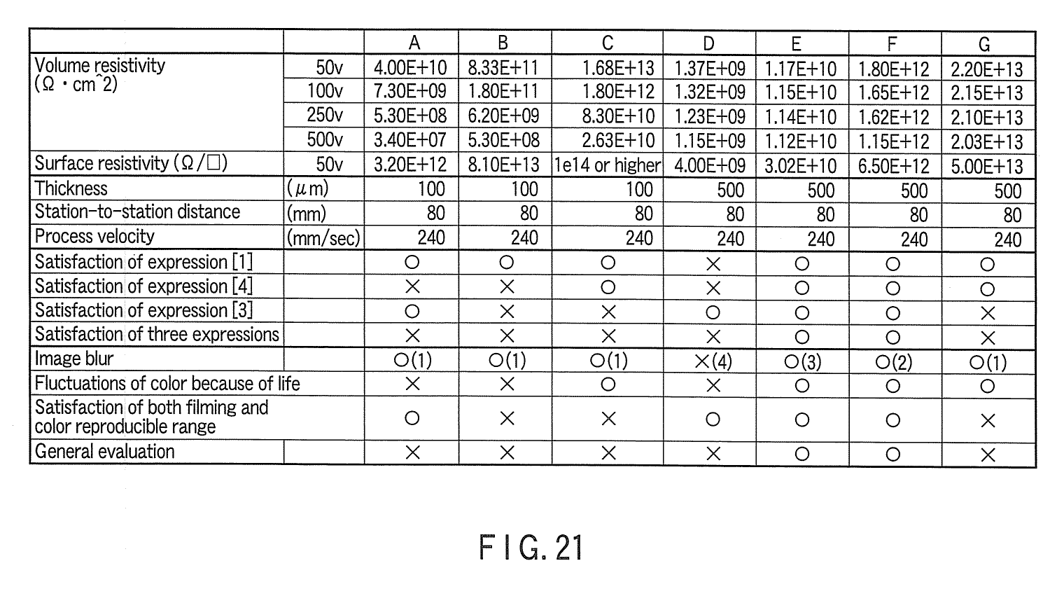

FIG. 21 shows results of printing test conducted using the belts A to G, respectively. In the color image forming apparatus 101 using the belt E and the belt F as the intermediate transfer belt 15, the problems of change in color by color mixture, color reproducible range, or filming do not occur, and a satisfactory image is obtained throughout the life.

### <Laminated Belt>

As described above, the satisfactory result is obtained by applying the non-electroconductive single layer belt which satisfies the conditional expressions (1), (2), (3) and (2′) as the intermediate transfer belt 15 of the color image forming apparatus 101 shown in FIG. 2. Also, the satisfactory result is obtained by applying the non-electroconductive single layer belt which satisfies the conditional expressions (1), (4), and (3) as the intermediate transfer belt 15 of the color image forming apparatus 101 in which the cleanerless process is applied shown in FIG. 10.

However, many of the non-electroconductive single layer belt are formed of rubber material or resin material which is vulnerable to stretch of the belt in many cases. The intermediate transfer belt 15 formed of such materials might be stretched every time when it expands and contracts during operation and hence lowering of the belt tension is resulted. Therefore, driving at a constant velocity becomes difficult, which is disadvantageous in the point of prevention from being out of color registration. In the color image forming apparatus 101, being out of color registration may be restrained to a predetermined level also with the rubber belt by devising a method of applying belt tension. However, the color image forming apparatus 101 becomes complicated, which may lead to cost increase, so that it is preferable to solve the problem of the belt itself.

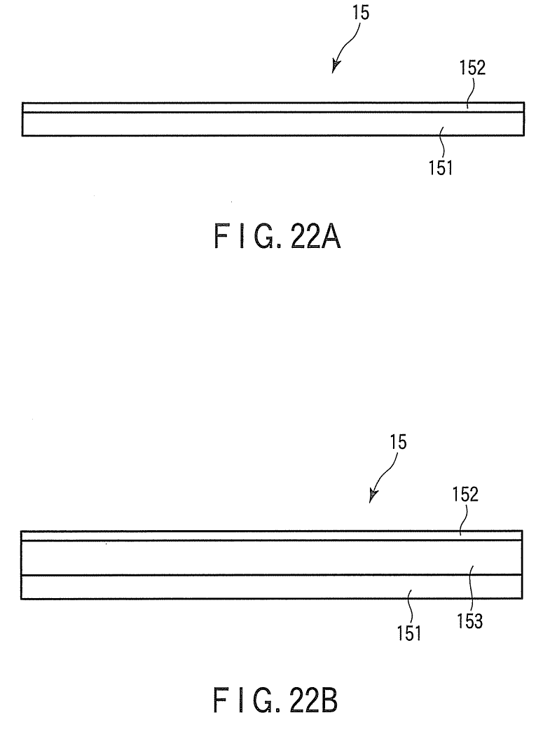

FIG. 22A is a side cross-sectional view of the intermediate transfer belt 15 showing an example in which a non-electroconductive surface layer 152 is formed on the surface of a base material layer 151 formed of an electroconductive resin belt. The material of the electroconductive base material layer 151 may be of any resin material such as polyimide, polyamide, polyimide amide, polycarbonate, PVDF, ETFE, and so on. As a material of the surface layer 152, Teflon contained, silicon contained, urethane contained, or nylon contained resin layer, or rubber layer may be employed. In order to clean the secondary untransferred toner adhered to the intermediate transfer belt 15 easily, it is needless to say that the material of the surface layer 152 needs to have a predetermined toner releasing property. Also, in order to reduce the operational cost of the color image forming apparatus 101, it is preferable to minimize the transfer bias, so that it is preferable to set the resistance of the base material layer 151 as low as possible.

However, if the resistance of the base material layer 151 is too low, an useless current flows in the lateral direction. Considering that the transfer current value of the maximum transfer bias (3000V) is more or less 200 μA, it is preferable to keep a leaked current to 10% thereof at maximum.

Here, it is assumed that the σ₅₀ (Ω/□) is the surface resistivity (measured value when applied with 50V), L1(m) is the belt width, and L2(m) is a nearer one of a horizontal distance from the primary transfer roller 12a of the Y station of the first stage to the backup roller 15c and a horizontal distance from the primary transfer roller 12d of the Bk station in the fourth stage to the drive roller 15a. At this time, the intermediate transfer belt 15 needs to satisfy the relation of 3000/(σb₅₀×L2/L1)<2×10⁻⁵.

When this expression is transposed, an expression;

σb₅₀>1.5×10⁸×L1/L2 (5)

is obtained.

In contrast, the surface resistivity of the surface layer 152 is relatively high with respect to the base material layer 151 in order to reduce character dispersion by satisfying the conditional expression (1) described above. Therefore, if the conditional expressions (2), (3), and (4) which should be satisfied for the single layer belt are applied to the laminated belt, they all seem to be able to be defined by the volume resistivity ps of the surface layer 152.

In the color image forming apparatus 101 shown in FIG. 2, since L2=0.1 (m) and L1=0.35 (m), σb₅₀ which satisfies the conditional expression (5) described above will be σb₅₀>1.5×10⁸×0.1/0.35, that is, σb₅₀>4.29×10⁷ (Ω/□).

Therefore, ten types of belts in total from a to j formed by combining the base material layer 151 having two different values of resistance which satisfies the conditional expression (5) (polycarbonate having carbon dispersed therein) and the surface layer 152 having five different values of resistance (surface resistivity and the volume resistivity) were prepared. The thickness of the base material layer 151 is 100 μm, the thickness of the surface layer 152 is varied within the range from 5 to 15 μm.

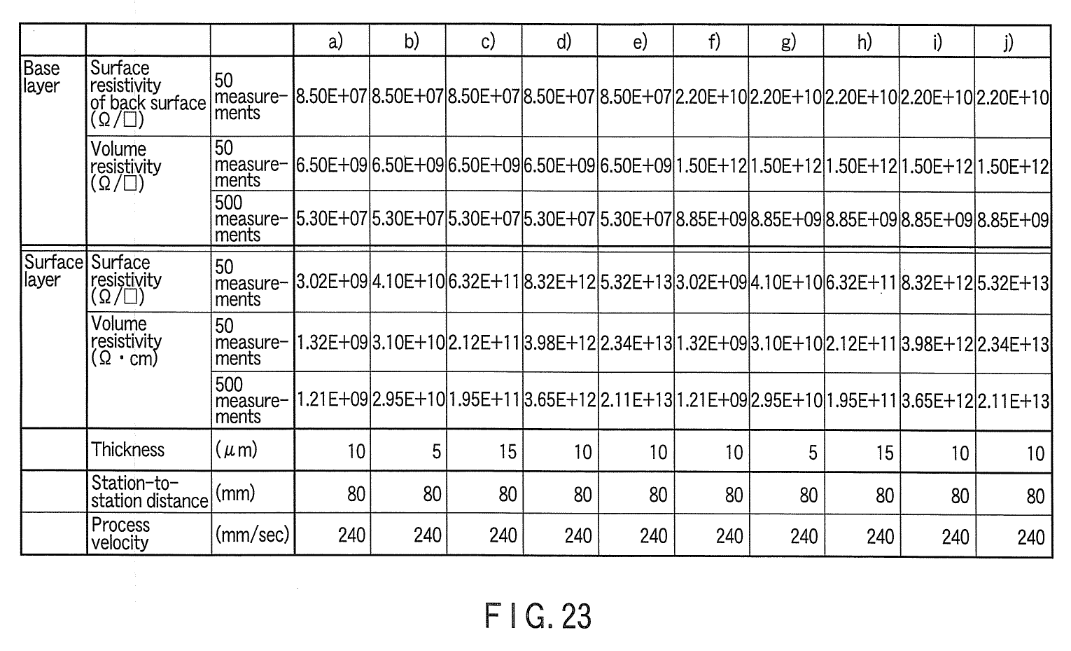

FIG. 23 shows the resistances of the base material layers 151 and the surface layers 152 and the thicknesses of the surface layers 152 of the belts a to j. The belts a, b, f, and g are composed of the urethane-contained surface layer 152, and belts c, d, h, and i are composed of the Teflon contained surface layer 152, and the belts e and j are composed of the silicon contained surface layer 152. The values of resistance of the base material layers 151 shown here are those measured before applying the surface layer 152 using R8340A (manufactured by ADVANTEST Corporation). The volume resistivities of the surface layers 152 are those measured by applying only the surface layers 152 to metallic substrates using the R8340A (manufactured by ADVANTEST Corporation).

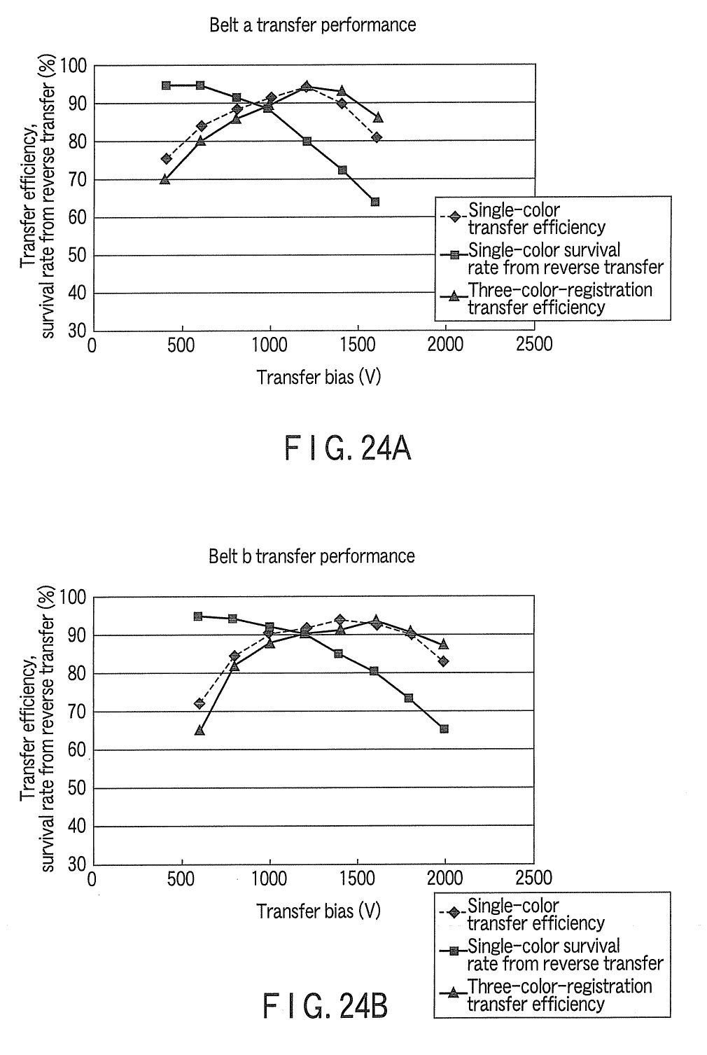

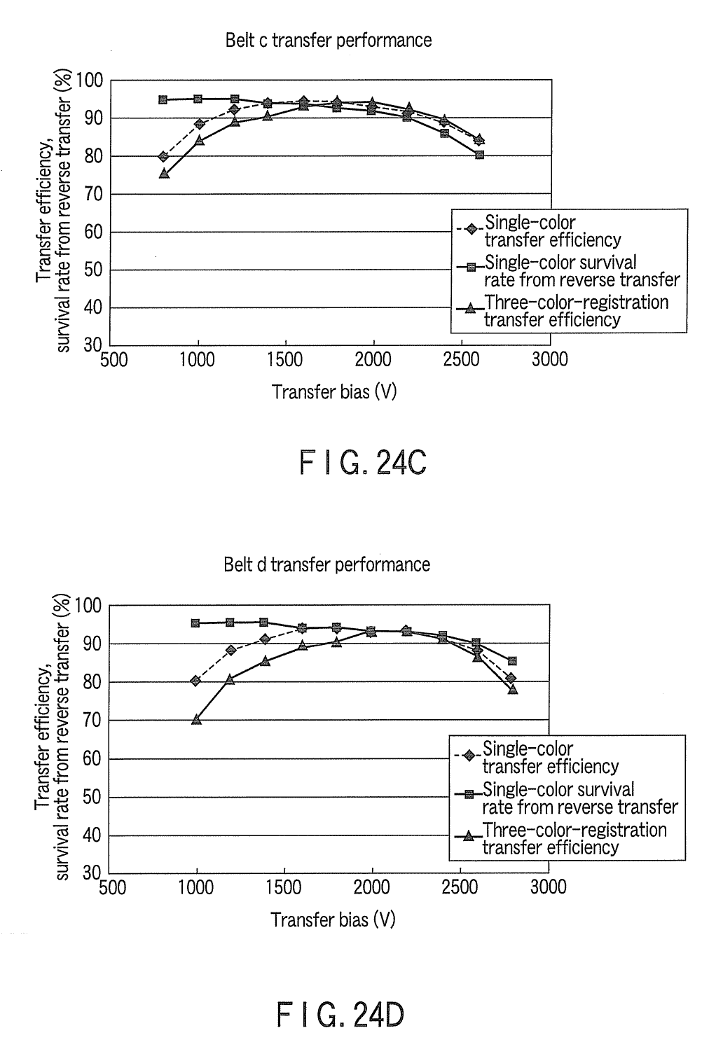

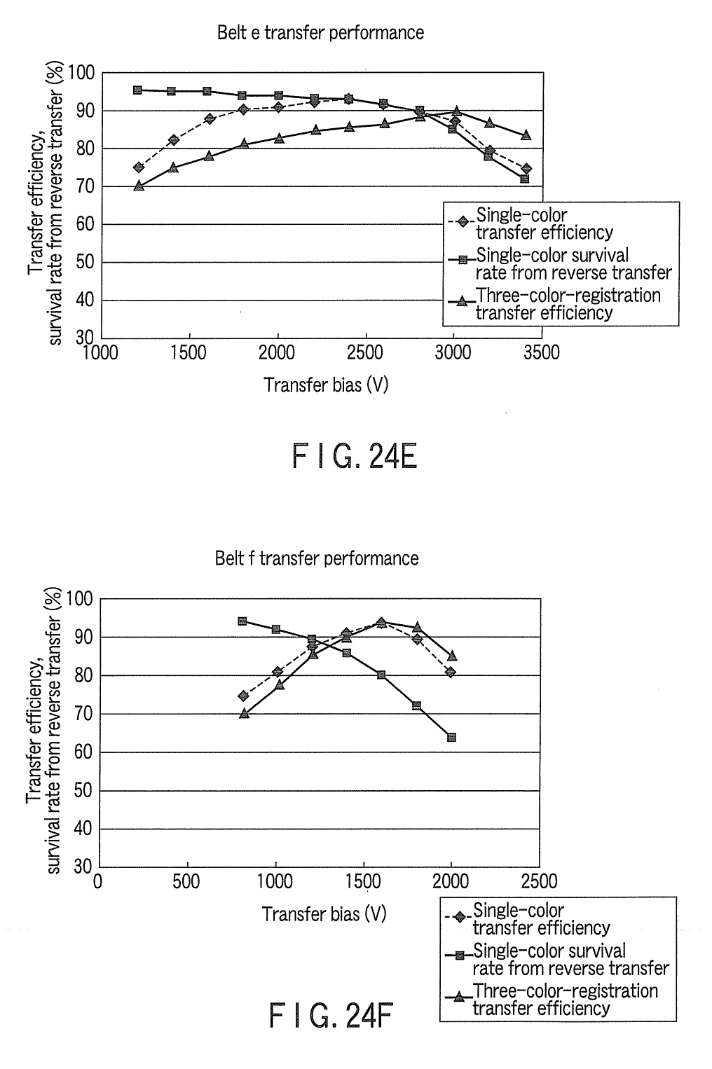

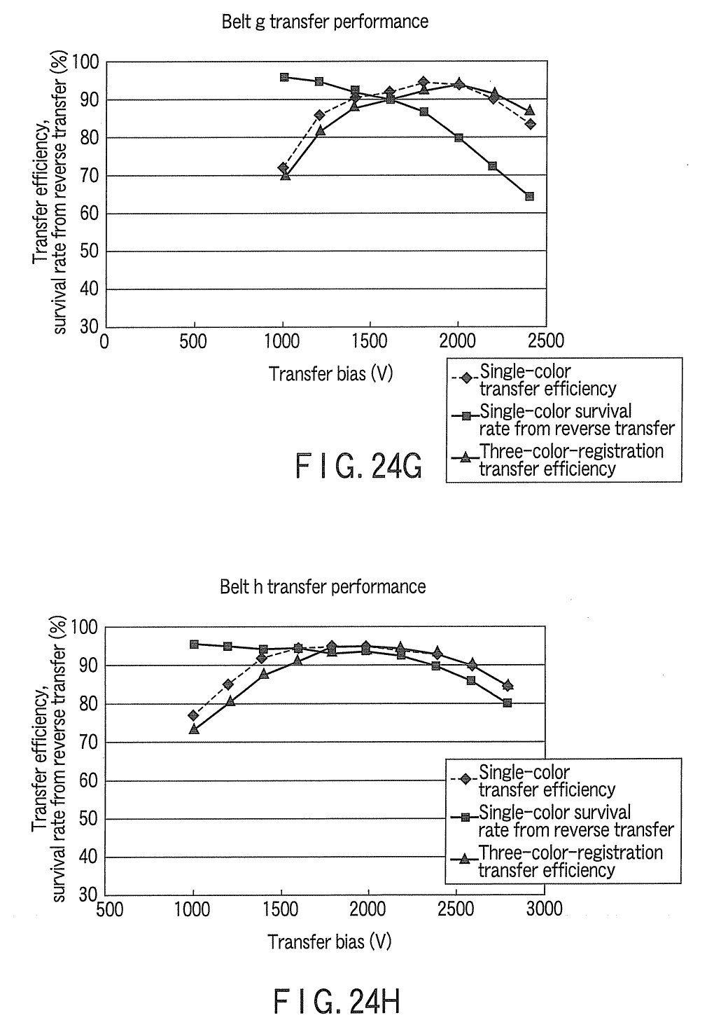

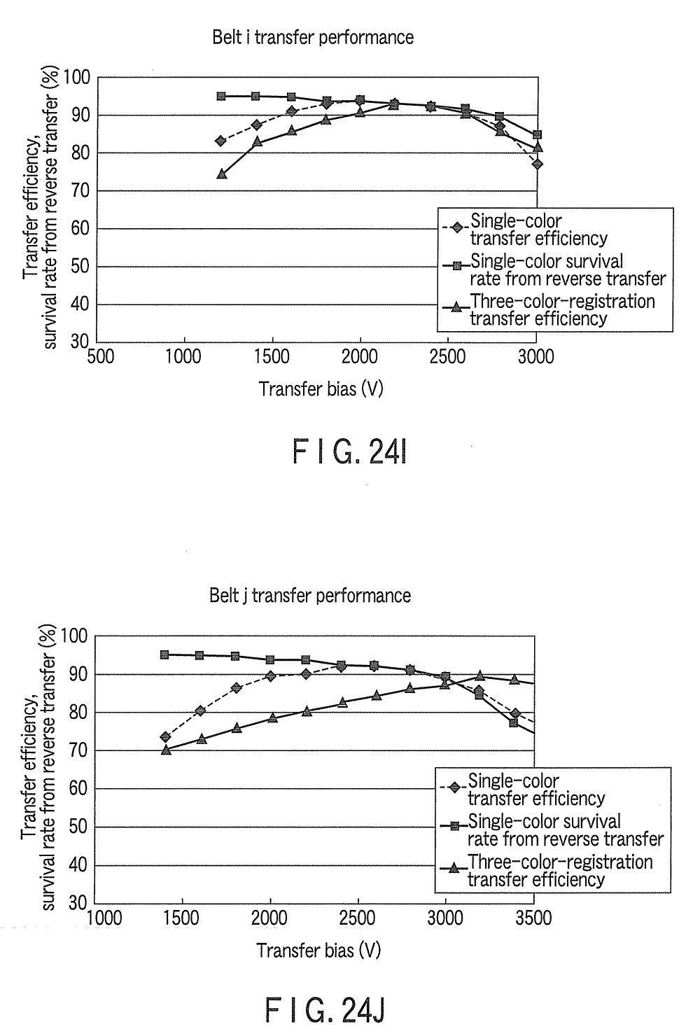

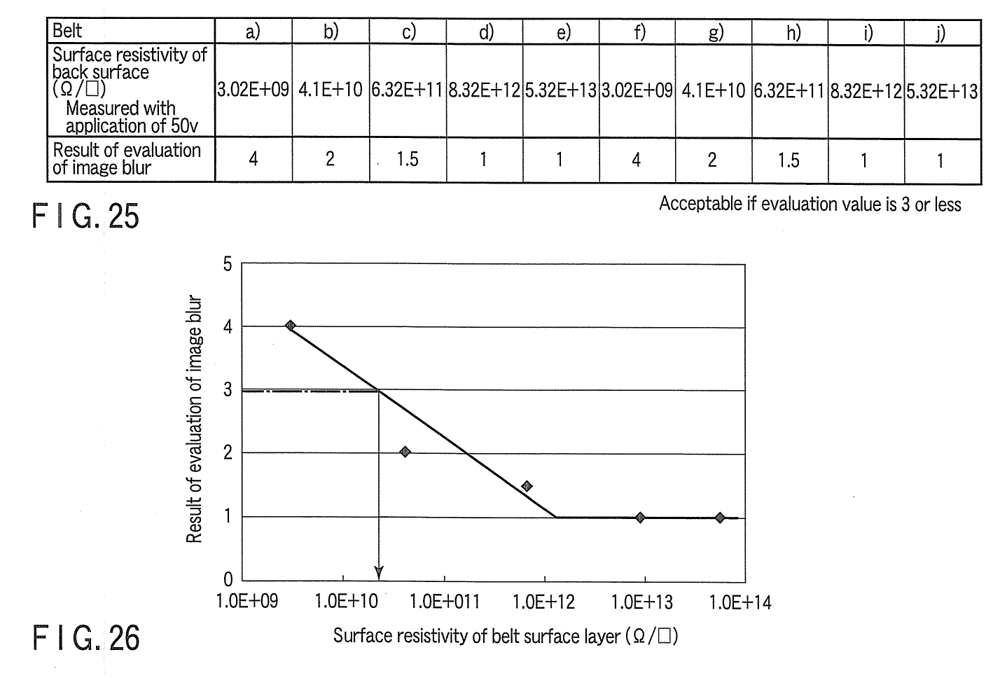

FIGS. 24A to 24J are graphs showing the results of evaluations of the single-color transfer efficiency, the three-color-registration transfer efficiency and the single-color survival rate from reverse transfer according to the transfer bias when the belts a to j are used respectively as the intermediate transfer belt 15 of the color image forming apparatus 101 shown in FIG. 2. Also, FIG. 25 shows the results of evaluations of the surface resistivity of the back surfaces and the image blurs when a voltage of 50V is applied respectively to the belts a to j. FIG. 26 is a graph showing the relation between a surface resistivity of the surface layer 152 and the results of evaluation of the image blur level.

From the result shown in FIG. 26, it is understood that a satisfactory image is obtained without the problem of image blur (character dispersion) if the surface resistivity σb₅₀ of the belt surface layer 152 satisfies the expression (6) shown below.

σs₅₀>2×10¹⁰ (Ω/□) (6)

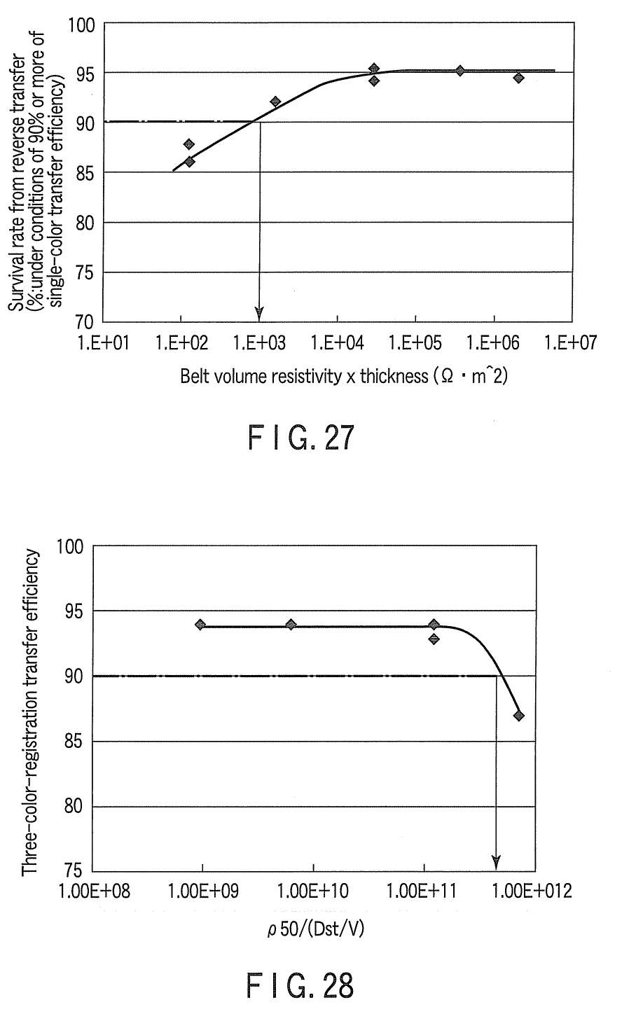

FIG. 27 is a graph in which the lateral axis represents the product (ρ₅₀₀·d) of the belt volume resistivity p₅₀₀ (Ω·m) measured with an applied voltage of 500V and the belt thickness d (m), and the vertical axis represents the maximum value of the single-color survival rate from reverse transfer within a range of transfer bias in which the single-color transfer efficiency is 90% or more. FIG. 28 is a graph in which a lateral axis represents ρ₅₀/(Dst/V), and a vertical axis represents the maximum value of the three-color-registration transfer efficiency within a transfer bias range which is able to achieve 90% or higher single-color transfer efficiency. As shown in FIG. 27 and FIG. 28, 90% or more of the single-color transfer efficiency and the three-color-registration transfer efficiency and 90% of the single-color survival rate from reverse transfer are realized if the expressions (7) and (8) are satisfied.

ρs₅₀₀·ds>1.0×10³ (Ω/m²) (7)

ρs₅₀/(Dst/V)>4.0×10¹¹ (Ω·m/sec) (8)

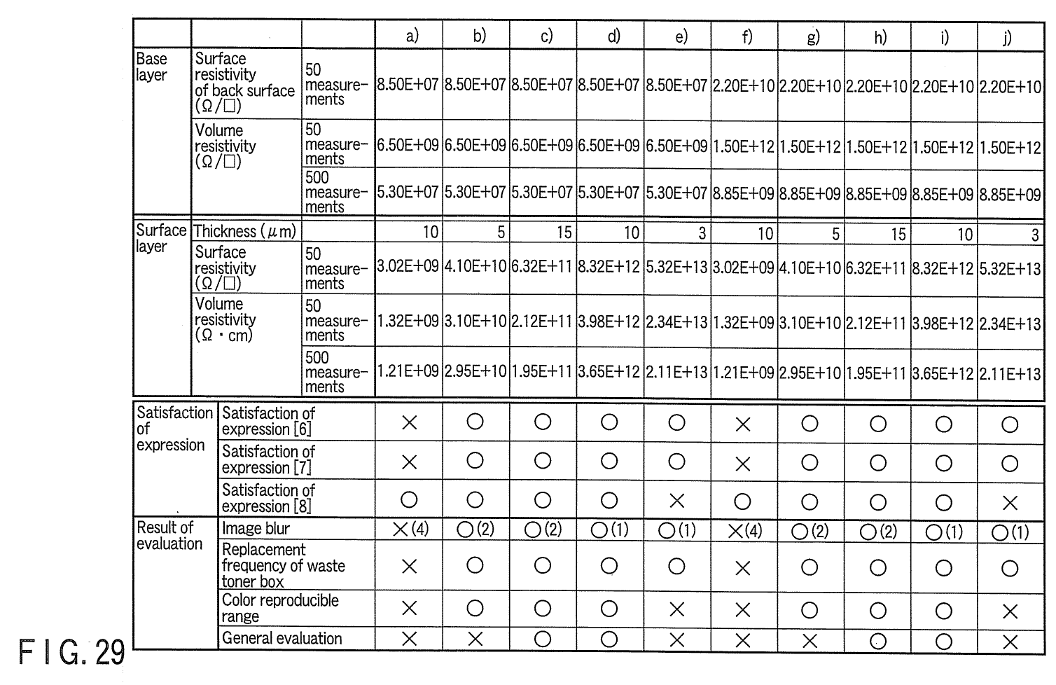

FIG. 29 is a drawing in which the states of satisfaction of the expressions (6), (7), and (8) of the respective belts a to j, the image blur, the states of achievement of 90% of the single-color transfer efficiency and the survival rate from reverse transfer, and the state of achievement of 90% of the single-color transfer efficiency and the three-color-registration transfer efficiency are shown. As shown in FIG. 29, the belts which satisfy all the expressions (6), (7), and (8), do not cause the image blur, and satisfy 90% or more of the single-color transfer efficiency and the three-color-registration transfer efficiency and 90% or more of the single-color survival rate from reverse transfer are only the belts c, d, h, and i.

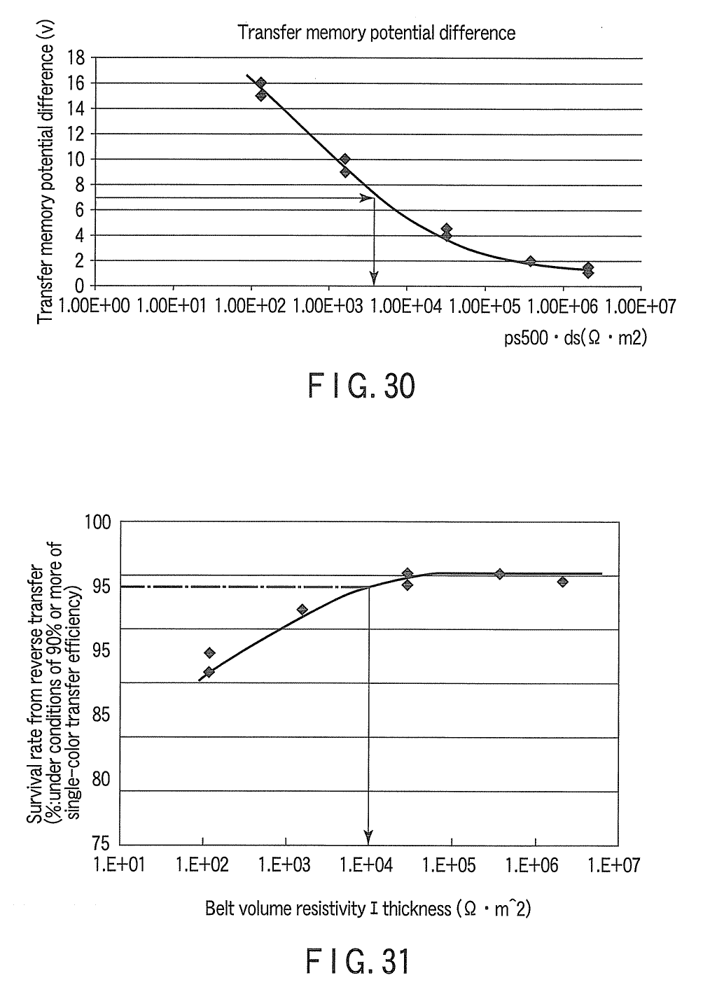

FIG. 30 is a graph showing the relation between the

ρs₅₀₀·ds if the belts a to j are used as the intermediate transfer belt 15 and the transfer memory potential difference with the adequate transfer bias.

If;

ρs₅₀₀ ds>3.0×10³ (Ω/m²) (7′)

is satisfied, the transfer memory potential difference is only a level in which the transfer memory concentration difference presents no problem (7V or lower).

As shown in FIG. 29, the belts which satisfy all the expressions (6), (7), (8), and (7′), do not cause the image blur, and satisfy 90% or more of the single-color transfer efficiency and the three-color-registration transfer efficiency, 90% or more of the survival rate from reverse transfer and below 0.03 of the transfer memory concentration difference are only the belts c, d, h, and i. Since the expression (7) is automatically satisfied if the condition of the expression (7′) is satisfied, it is essentially only that the expressions (6), (8), and (7′) are satisfied.

A life test was conducted with the belts c, d, h, and i as the intermediate transfer belt 15 on the 100 k pieces of paper, and the problem of lowering operability of the color image forming apparatus 101 due to the insufficient image concentration, fluctuations of the image color, or frequent replacement of the waste toner box did not occur. Consequently, if the expression (5) is satisfied by using the laminated intermediate transfer belt 15 having the non-electroconductive surface layer 152, useless flow of the transfer current through the base material layer 151 does not occur. If the expression (6) is satisfied, the image blur (character dispersion) does not occur. If the expressions (7) and (8) are satisfied, 90% or more of the single-color transfer efficiency, 90% or more of the three-color-registration transfer efficiency, and 90% or more of the single-color survival rate from reverse transfer are satisfied, and a high-quality image having no blur and a satisfactory color reproducible range without the problem of the replacement frequency of the waste toner box is obtained. If the expression (9) is satisfied, a high-quality image with the transfer memory concentration difference below 0.03 is obtained.

In the color image forming apparatus 101 in which the cleanerless process is applied, the problems of the color mixture or the filming cannot be solved unless 94% of the single-color survival rate from reverse transfer and 90% or more of the single-color transfer efficiency and the three-color-registration transfer efficiency are achieved as described above.

If the belts a to j are used as the intermediate transfer belt 15 in the color image forming apparatus 101 in which the cleanerless process is applied as shown in FIG. 10, the results of measurement of the single-color transfer efficiency of Cyan, three-color-registration transfer efficiency, and single-color survival rate from reverse transfer of Cyan match those in FIGS. 24A to 24J.

FIG. 31 is a graph in which the lateral axis represents the product (ρ₅₀₀·d) of the belt volume resistivity ρ₅₀₀ (Ω·m) and the belt thickness d (m), and the vertical axis represents the maximum value of the single-color survival rate from reverse transfer within a range of transfer bias in which the single-color transfer efficiency is 90% or more. FIG. 28 is a graph in which a lateral axis represents ρ₅₀/(Dst/V), and a vertical axis represents the maximum value of the three-color-registration transfer efficiency within a transfer bias range which is able to achieve 90% or more single-color transfer efficiency.

If the expression (5) is satisfied, the useless flow of the transfer current through the base material layer 151 does not occur. If the expression (6) is satisfied, the image blur (character dispersion) does not occur. If the expressions (9) and (8) are satisfied, 90% or more of the single-color transfer efficiency, 90% or more of the three-color registration transfer efficiency, and 94% or more of the single-color survival rate from reverse transfer are satisfied, and a high-quality image having no defective image due to the photoconductor filming or color mixture due to the reverse transfer is obtained.

ρs₅₀₀·ds>1.0×10⁴ (Ω/m²) (9)

ρs₅₀/(Dst/V)>4.0×10¹¹ (Ω·m/sec) (8)

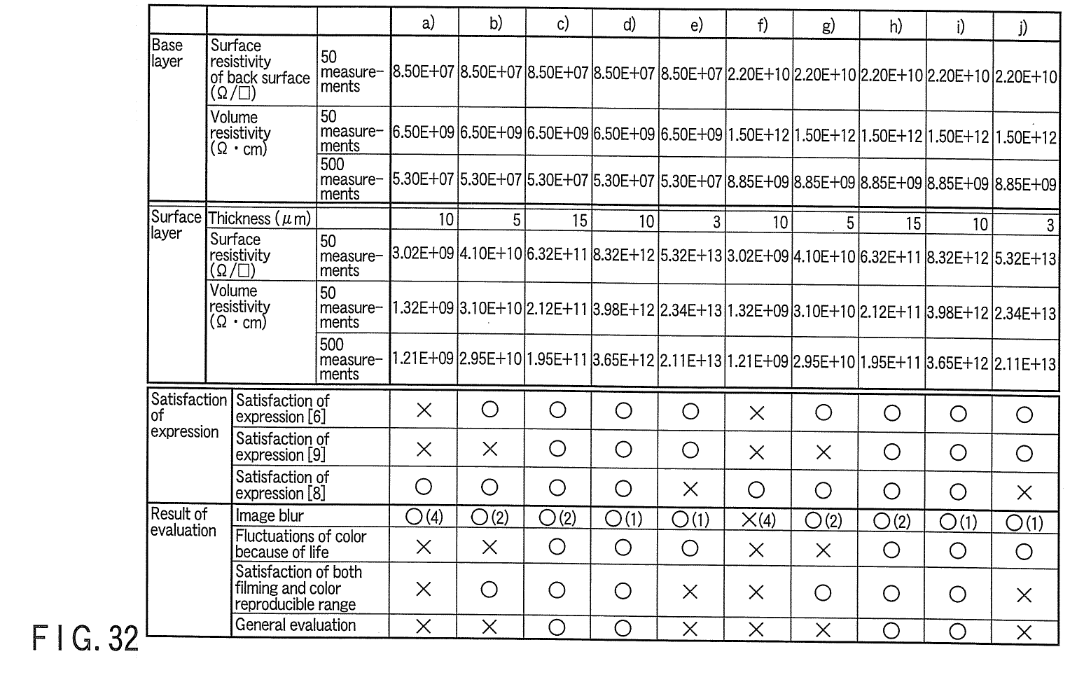

FIG. 32 is a drawing in which the states of satisfaction of the expressions (6), (9), and (8) of the respective belts a to j, the image blur, the states of achievement of 90% of the single-color transfer efficiency and 94% of the survival rate from reverse transfer, and the state of achievement of 90% of the single-color transfer efficiency and the three-color registration transfer efficiency are shown. As shown in FIG. 32, the belts which satisfy all the expressions (6), (9), and (8), do not cause the image blur, and satisfy 90% or more of the single-color transfer efficiency and the three-color-registration transfer efficiency and 94% or more of the survival rate from reverse transfer are only the belts c, d, h, and i.

A life test was conducted with the belts c, d, h, and i as the intermediate transfer belt 15 on the 100 k pieces of paper, and the problem of the image blur, color change because of its life, insufficient images due to the photoconductor filming, or the color reproducible range did not occur.

Consequently, if the expression (5) is satisfied by using the laminated intermediate transfer belt 15 having the non-electroconductive surface layer 152, useless flow of the transfer current through the base material layer 151 does not occur. If the expression (6) is satisfied, the image blur does not occur. If the expressions (9) and (8) are satisfied, 90% or more of the single-color transfer efficiency, 90% or more of the three-color registration transfer efficiency, and 94% or more of the single-color survival rate from reverse transfer are satisfied, and a high-quality image with a satisfactory color reproducible range and having no color change because of the life and no occurrence of insufficient images due to the filming is obtained.

If the developing devices 13a to 13d are two-component developing devices, the photoconductive drums 11a to 11d might be formed with a hole due to carrier adhered to the photoconductive drums 11a to 11d sandwiched between the photoconductive drums 11a to 11d and the intermediate transfer belt 15, thereby generating defective images.

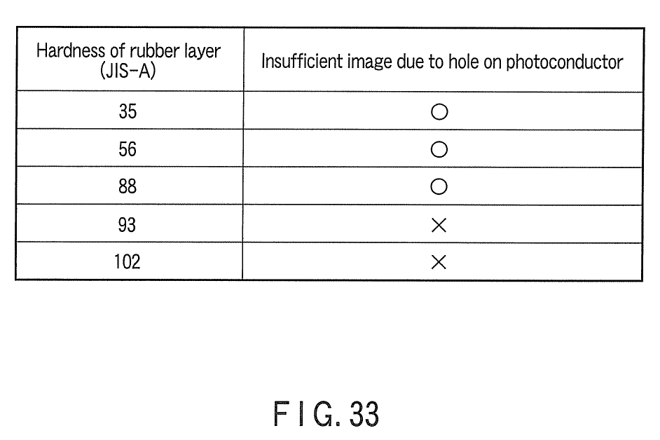

In such a case, by employing a three-layer belt structure including an elastic layer 153 between the base material layer 151 and the surface layer 152 as in FIG. 22B, a satisfactory image having satisfactory single-color transfer efficiency, the three-color-registration transfer efficiency and single-color survival rate from reverse transfer with no character dispersion and also no insufficient image due to the hole on the photoconductor caused by the carrier is obtained. FIG. 33 is a drawing showing the insufficient image due to the hole on the photoconductor according to the rubber strength of the elastic layer 153. It is understood that the rubber layer hardness JIS-A not exceeding 90 degrees is effective. Since the rubber with low hardness has a problem in mold releasing property of the toner, the surface layer 152 formed of Teflon resin, fluorine contained resin, or silicon contained resin is formed on the surface of the elastic layer 153.

When the three-layer belt shown in FIG. 22B is applied to the color image forming apparatus 101 shown in FIG. 2, if the surface layer 152 satisfies the expressions (6), (7), and (8), the effect of this embodiment is achieved. Also, when the three-layer belt shown in FIG. 22B is applied to the color image forming apparatus 101 in which the cleanerless process is applied as show in FIG. 10, if the surface layer 152 satisfies the expressions (6), (9), and (8), the effect of this embodiment is achieved. In this case, the resistance of the base material layer 151 needs to satisfy the expression (5) as a matter of course.

As described thus far, by applying the intermediate transfer belt 15 in this embodiment to the color image forming apparatus 101, a high-quality color image having 90% or more of both the single-color transfer efficiency, the three-color-registration transfer efficiency and the single-color survival rate from reverse transfer, consuming less amount of toner, and having no difference in transfer memory concentration is obtained. Also, if the intermediate transfer belt 15 according to this embodiment is applied to the color image forming apparatus 101 in which the cleanerless process is applied, a satisfactory image having no deterioration in quality due to the color mixture and causing no photoconductor filming is obtained. In addition, by applying the laminated belt to the intermediate transfer belt 15, the hole on the photoconductor caused by the carrier in the two-component developer does not occur, and impairment of the lifetime of the photoconductive drums 11a to 11d is prevented.

What is claimed is:

1. An image forming apparatus comprising:
a plurality of image carrier members each configured to carry a latent image;
a plurality of electrostatic chargers each configured to charge the image carrier member uniformly;
a plurality of developing devices each configured to develop the latent image formed to the image carrier member by toner;
a plurality of cleaners each configured to remove the toner remaining on the carrier member;
an intermediate transfer member having a non-electroconductive material on which a developed image is transferred by one of the image carrier members and then another developed image is transferred over the developed image by another image carrier member;
a plurality of transfer rollers each provided so as to oppose the image carrier member with the intermediary of the intermediate transfer member;
a first roller provided on the upstream side in the direction of travel of the intermediate transfer member; and
a second roller provided on the downstream side in the direction of travel of the intermediate transfer member,
wherein the intermediate transfer member satisfies conditions of σ₅₀>2.0×10¹⁰ (Ω/□), ρ₅₀₀·d>1.0×10³ (Ω·m²), and ρ₅₀/(Dst/V)<4.0×10¹¹ (Ω·m/sec) where Dst is a distance (m) between the adjacent image carrier members, V is a traveling velocity (m/sec) of the intermediate transfer member, d is a thickness (m) of the intermediate transfer member, σ₅₀ is a surface resistivity measured with an applied voltage of 50V, ρ₅₀₀ is a volume resistivity measured with an applied voltage of 500V, and ρ₅₀ is a volume resistivity measured with an applied voltage of 50V.

2. The apparatus of claim 1, wherein:
the intermediate transfer member is formed with a surface layer formed of the non-electroconductive material and a base material layer formed of an electroconductive material in sequence from the side of being in contact with the image carrier member.

3. The apparatus of claim 2, wherein:
the base material layer has a surface resistivity of the base material layer measured with an applied voltage of 50V, which satisfies a relation of σ₅₀>1.5×10⁸×L1/L2, where L1(m) is a width in the direction orthogonal to the direction of travel of the intermediate transfer member and, if there are provided four sets of the image carrier member and the transfer roller from first to fourth stages, L2(m) is a nearer one of a horizontal distance from the transfer roller of the first stage to the first roller and a horizontal distance from the transfer roller in the fourth stage to the second roller.

4. The apparatus of claim 3, wherein:
the surface layer is formed of a Teflon contained material.

5. The apparatus of claim 4, wherein:
the base material layer is formed of a resin material.

6. The apparatus of claim 5, comprising: an elastic layer between the base material layer and the surface layer.

7. The apparatus of claim 6, wherein:
the hardness of the elastic layer does not exceed 90 degrees.

8. An image forming apparatus comprising:
a plurality of image carrier members each configured to carry a latent image;
a plurality of electrostatic chargers each configured to charge the image carrier member uniformly;
a plurality of developing devices each configured to develop the latent image formed on the image carrier member by toner and collecting the toner on the image carrier member;
an intermediate transfer member having a non-electroconductive material on which a developed image is transferred by one of the image carrier members and then another developed image is transferred over the developed image by another image carrier member;
a plurality of transfer rollers each provided so as to oppose the image carrier member with the intermediary of the intermediate transfer member;
a first roller provided on the upstream side in the direction of travel of the intermediate transfer member; and
a second roller provided on the downstream side in the direction of travel of the intermediate transfer member,
wherein the intermediate transfer member satisfies conditions of σ₅₀>2.0×10¹⁰ (Ω/□), ρ₅₀₀·d>1.0×10⁴ (Ω·m²), and ρ₅₀/(Dst/V)<4.0×10¹¹ (Ω·m/sec) where Dst is a distance (m) between the adjacent image carrier members, V is a traveling velocity (m/sec) of the intermediate transfer member, d is a thickness (m) of the intermediate transfer member, σ₅₀ is a surface resistivity measured with an applied voltage of 50V, ρ₅₀₀ is a volume resistivity measured with an applied voltage of 500V, and ρ₅₀ is a volume resistivity measured with an applied voltage of 50V.

9. The apparatus of claim 8, comprising:
a plurality of blending members each configured to blend untransferred toner on the surface of the image carrier member after the transfer of the developed image to the intermediate transfer member by the image carrier member.

10. The apparatus of claim 9, wherein:
the intermediate transfer member is formed with a surface layer formed of the non-electroconductive material and a base material layer formed of an electroconductive material in sequence from the side of being in contact with the image carrier member.

11. The apparatus of claim 10, wherein:
the base material layer has a surface resistivity of the base material layer measured with an applied voltage of 50V, which satisfies a relation of σb₅₀>1.5×10⁸×L1/L2, where L1(m) is a width in the direction orthogonal to the direction of travel of the intermediate transfer member and, if there are provided four sets of the image carrier member and the transfer roller from first to fourth stages, L2(m) is a nearer one of a horizontal distance from the transfer roller of the first stage to the first roller and a horizontal distance from the transfer roller in the fourth stage to the second roller.

12. The apparatus of claim 11, wherein:
the surface layer is formed of a Teflon contained material.

13. The apparatus of claim 12, wherein:
the base material layer is formed of a resin material.

14. The apparatus of claim 13, comprising: an elastic layer between the base material layer and the surface layer.

15. An image forming apparatus comprising:
a plurality of image carrier members each configured to carry a latent image;
a plurality of electrostatic chargers each configured to charge the image carrier member uniformly by applying DC bias;
a plurality of developing devices each configured to develop the latent image formed to the image carrier member by toner;
a plurality of cleaners each configured to remove the toner remaining on the carrier member;
an intermediate transfer member having a non-electroconductive material on which a developed image is transferred by one of the image carrier members and then another developed image is transferred over the developed image by another image carrier member;
a plurality of transfer rollers each provided so as to oppose the image carrier member with the intermediary of the intermediate transfer member;
a roller provided on the upstream side in the direction of travel of the intermediate transfer member; and
a second roller provided on the downstream side in the direction of travel of the intermediate transfer member,
wherein the intermediate transfer member satisfies conditions of σ₅₀>2.0×10¹⁰ (Ω/□), ρ₅₀₀·d>3.0×10³ (Ω·m²), and ρ₅₀/(Dst/V)<4.0×10¹¹ (Ω·m/sec) where Dst is a distance (m) between the adjacent image carrier members, V is a traveling velocity (m/sec) of the intermediate transfer member, d is a thickness (m) of the intermediate transfer member, σ₅₀ is a surface resistivity measured with an applied voltage of 50V, ρ₅₀₀ is a volume resistivity measured with an applied voltage of 500V, and ρ₅₀ is a volume resistivity measured with an applied voltage of 50V.

16. The apparatus of claim 15, wherein:
the intermediate transfer member is formed with a surface layer formed of the non-electroconductive material and a base material layer formed of an electroconductive material in sequence from the side of being in contact with the image carrier member.

17. The apparatus of claim 16, wherein:
the base material layer satisfies a relation of σb₅₀>1.5×10⁸×L1/L2, where L1(m) is a width in the direction orthogonal to the direction of travel of the intermediate transfer member and, if there are provided four sets of the image carrier member and the transfer roller from the first to fourth stages, L2(m) is a nearer one of a horizontal distance from the transfer roller of the first stage to the first roller and a horizontal distance from the transfer roller in the fourth stage to the second roller, and σb₅₀ is a surface resistivity of the base material layer measured with an applied voltage of 50V.

18. The apparatus of claim 17, wherein:
the surface layer is formed of a Teflon contained material.

19. The apparatus of claim 18, wherein:
the base material layer is formed of a resin material.

20. The apparatus of claim 19, comprising: an elastic layer between the base material layer and the surface layer.
